(19) United States
(12) Patent Application Publication
(10) Pub. No.: US 2026/0025729 A1
(43) Pub. Date: Jan. 22, 2026

(54) METHOD AND ELECTRONIC DEVICE FOR HANDLING CONDITIONAL HANDOVER IN WIRELESS COMMUNICATION SYSTEM

(71) Applicant: Samsung Electronics Co., Ltd., Gyeonggi-do (KR)

(72) Inventors: Yu PAN, Beijing (CN); Weiwei WANG, Beijing (CN); Hong WANG, Beijing (CN); Lixiang XU, Beijing (CN)

(21) Appl. No.: 18/997,347

(22) PCT Filed: Jul. 27, 2023
(86) PCT No.: PCT/KR2023/010910

§ 371 Date: Jan. 21, 2025

(30) Foreign Application Priority Data
Jul. 27, 2022 (CN) 202210893883.8
Apr. 14, 2023 (CN) 202310403764.4

(51) Int. Cl. H04W 36/36; H04W 36/00; H04W 76/20

(52) U.S. Cl. CPC H04W 36/362; H04W 36/0058; H04W 76/20

(57) ABSTRACT

The disclosure relates to a 5G or 6G communication system for supporting a higher data transmission rate. A method executed of a first node in a wireless communication system is provided. The method comprise receiving a handover request message from a third node, wherein the handover request message includes at least one of conditional handover (CHO) trigger indication information and information indicating the maximum number of primary secondary cell group (SCG) cells (PSCells) to prepare, and transmitting a first message to a second node, wherein the first message includes at least one of a candidate PCell ID or a configuration ID and the information indicating the maximum number of PSCells to prepare.

### TECHNICAL FIELD

The present disclosure relates to the technical field of communication, and in particular, the present disclosure relates to a node and an execution method in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mm Wave including 28 GHZ and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, notebooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In the communication system, in order to improve the reliability and robustness of handover and the system throughput, how to better improve the existing handover mechanism to better meet the communication requirements is an important issue which those skilled in the art have been working hard on.

### DISCLOSURE OF INVENTION

### Solution to Problem

The present disclosure provides a node and an execution method in a wireless communication system, in order to solve at least one of technical defects in the existing communication methods and further improve the communication methods, thus to better meet actual communication requirements. For this purpose, following technical solutions will be employed.

According to an aspect of the present disclosure, a method for handling a conditional handover (CHO) by a first node in a wireless communication system is provided. The method may comprise receiving a handover request message from a third node, wherein the handover request message includes at least one of conditional handover (CHO) trigger indication information and information indicating the maximum number of primary secondary cell group (SCG) cells (PSCells) to prepare; and transmitting a first message to a second node, wherein the first message includes at least one of a candidate PCell ID or a configuration ID and the information indicating the maximum number of PSCells to prepare.

The method may further comprise receiving a second message in response to the first message from the second node. The second message may include a candidate PCell ID or a configuration ID, and candidate PSCell list information related to the candidate PCell ID or the configuration ID.

The method may further comprise transmitting a handover request acknowledge message to the third node. The the handover request acknowledge message may include at least one of one or more cell radio network temporary identifiers (C-RNTIs) of a terminal, one or more cell group configuration IDs (CG configuration IDs), the information indicating a number of candidate PSCells to prepare, conditional PSCell addition/change (CPAC) evaluation maintenance information, CPAC monitoring range information, and monitoring timer.

The method may further comprise receiving a fourth message from the second node; or transmitting a sixth message to the second node. The fourth message or the sixth message may include the candidate PCell ID or the configuration ID, and may be used to indicate completion or acknowledgement of the cancel request or the SCG configuration modification of the candidate PSCell corresponding to the candidate PCell ID.

The method may further comprise transmitting a seventh message to the third node. The seventh message includes at least one of ID information of a terminal, a candidate PCell ID and a handover command message, and may be used to instruct to modify or update handover configuration information.

The method may further comprise receiving an eighth message from a terminal, The eighth message includes at least one of a CG configuration ID, PSCell list information, and measurement results.

The method may further comprise transmitting a ninth message to the third node. The ninth message may include an ID of a target PSCell, and is used to instruct a terminal to select the target PSCell.

The method may further comprise transmitting, by a central unit-control plane (CU-CP) of the first node, a tenth message to a central unit-user plane (CU-UP) of the first node. The tenth message includes indirect data forwarding indication information.

According to an aspect of the present disclosure, an electronic device of a first node for handling a conditional handover (CHO) in a wireless communication system is provided. The electronic device may comprise a transceiver; and a processor coupled to the transceiver. The processor may be configured to receive a handover request message from a third node, wherein the handover request message includes at least one of conditional handover (CHO) trigger indication information and information indicating the maximum number of primary secondary cell group (SCG) cells (PSCells) to prepare; and transmit a first message to a second node, wherein the first message includes at least one of a candidate PCell ID or a configuration ID and the information indicating the maximum number of PSCells to prepare.

According to an aspect of the present disclosure a non-transitory computer-readable storage medium storing instructions is provided. The instructions, when executed by a processor of an electronic device, cause the electronic device to perform operations. The operations may comprise receiving a handover request message from a third node, wherein the handover request message includes at least one of conditional handover (CHO) trigger indication information and information indicating the maximum number of primary secondary cell group (SCG) cells (PSCells) to prepare; and transmitting a first message to a second node, wherein the first message includes at least one of a candidate PCell ID or a configuration ID and the information indicating the maximum number of PSCells to prepare.

According to an aspect of the present disclosure, a method of a second node in a wireless communication system is provided. The method may comprise receiving a first message sent by a first node, wherein the first message contains at least one of a candidate PCell ID or a configuration ID and second indication information, wherein the second indication information indicates the maximum number of PSCells to prepare; and sending a second message in response to the first message to the first node, wherein the second message contains a candidate PCell ID or a configuration ID, and candidate PSCell list information related to the candidate PCell ID or configuration ID.

The method may comprise receiving a third message sent by the first node; or sending a fifth message to the first node, wherein the third message or the fifth message contains a candidate PCell ID or a configuration ID, and is used to indicate a cancel request or an SCG configuration modification request for a candidate PSCell corresponding to the candidate PCell.

The method may comprise sending a fourth message to the first node; or receiving a sixth message sent by the first node, wherein the fourth message or the sixth message contains a candidate PCell ID or a configuration ID, and is used to indicate completion or acknowledgement of the cancellation or SCG configuration modification of a candidate PSCell corresponding to the candidate PCell.

According to an aspect of the present disclosure, a method of in a wireless communication system is provided. The method may comprise including sending a handover request message to a first node, wherein the handover request message contains at least one of CHO trigger indication information and first indication information, and the first indication information indicates the maximum number of PSCells to prepare; and receiving a handover request acknowledge message sent by the first node, wherein the handover request acknowledge message contains at least one of one or more cell radio network temporary identifiers (C-RNTIs) of a terminal or one or more cell group configuration IDs (CG configuration IDs), indication information of the number of candidate PSCells to prepare, CPAC evaluation maintenance indication information, CPAC monitoring range indication information, and monitoring timer.

The method may comprise receiving a seventh message sent by the first node, wherein the seventh message contains at least one of ID information of a terminal, a candidate PCell ID, and a handover command message, and is used to instruct to modify/update handover configuration information.

The method may comprise receiving a ninth message sent by the first node, wherein the ninth message contains an ID of a target PSCell, and is used to instruct a terminal to select the target PSCell.

The method may comprise sending an eleventh message to a terminal, wherein the eleventh message is used to send handover information, containing at least one of CHO execution conditions, CPAC execution conditions, C-RNTIs, CG configuration IDs, CPAC evaluation maintenance indication information, CPAC monitoring range indication information, and monitoring timer.

The method may comprise sending a twelfth message to a fourth node, wherein the twelfth message at least contains an ID of a target PSCell, and is used to instruct a terminal to select the target PSCell.

The method may comprise sending, by the CU-CP of a third node, a thirteenth message to the CU-UP of the third node, wherein the thirteenth message contains indirect data forwarding indication information.

According to an aspect of the present disclosure, a method of a terminal in a wireless communication system is provided. The method may comprise sending an eighth message to a first node, wherein the eighth message contains at least one of a CG configuration ID, PSCell list information, and measurement results.

The method may comprise receiving an eleventh message sent by a third node, wherein the eleventh message is used to send handover information, containing at least one of CHO execution conditions, CPAC execution conditions, C-RNTIs, CG configuration IDs, CPAC evaluation maintenance indication information, CPAC monitoring range indication information, and monitoring timer.

According to an aspect of the present disclosure, a method of a sixth node in a wireless communication system is provided. The method may comprise receiving a tenth message sent by a fifth node, wherein the tenth message contains indirect data forwarding indication information; and based on the indirect data forwarding indication information, a sixth node does not need to process the service data from a second node.

According to an aspect of the present disclosure, a method executed of an eighth node in a wireless communication system. The method may comprise receiving a thirteenth message sent by a seventh node, wherein the thirteenth message contains indirect data forwarding indication information; and based on the indirect data forwarding indication information, an eighth node does not need to process the service data from a ninth node.

The technical solutions of the present disclosure have the following beneficial effects.

The present disclosure proposes CHO+CPAC handover mechanism management, so as to realize the effective utilization of the CHO+CPAC mechanism. The method further ensures the optimal selection of PSCells under the CHO mechanism, thereby ensuring the robustness and reliability of UE handover, and improving the system throughput while improving the handover performance.

### BRIEF DESCRIPTION OF DRAWINGS

To describe the technical solutions of the embodiments of the present disclosure more clearly, the drawings to be used in the description of the embodiments of the present disclosure will be described briefly below.

FIG. 1 is a schematic flowchart of a method executed by a first node according to an embodiment of the present disclosure;

FIG. 2 is a system architecture diagram of system architecture evolution (SAE);

FIG. 3 is an exemplary system architecture diagram according to various embodiments of the present disclosure;

FIG. 4 is a schematic diagram of the process of a configuration information indication method under the mechanism of CHO+CPAC;

FIG. 5 is a schematic diagram of the process of a configuration information update indication method under the mechanism of CHO+CPAC;

FIG. 6 is a schematic diagram of the process of a configuration information update indication method under the mechanism of CHO+CPAC;

FIG. 7 is a schematic diagram of the process of a configuration information update indication method under the mechanism of CHO+CPAC;

FIG. 8 is a schematic diagram of the process of a configuration information update indication method under the mechanism of CHO+CPAC;

FIGS. 9A and 9B are a schematic diagram of the process of an execution method under the mechanism of CHO+CPAC;

FIGS. 10A and 10B are a schematic diagram of the process of an execution method under the mechanism of CHO+CPAC;

FIGS. 11A and 11B are a schematic diagram of the process of an execution method under the mechanism of CHO+CPAC;

FIGS. 12A and 12B are a schematic diagram of the process of a forwarded data transmission method;

FIG. 13 is a schematic diagram of the process of a forwarded data transmission method;

FIG. 14 is a schematic structure diagram of an electronic device according to an embodiment of the present disclosure;

FIG. 15 is a schematic diagram of the process of another forwarded data transmission method;

FIG. 16 is a schematic diagram of the process of another forwarded data transmission method; and

FIG. 17 is a schematic diagram of the process of another forwarded data transmission method.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

When describing the embodiments of the present disclosure, descriptions related to technical contents known in the art but not directly related to the present disclosure may be omitted. Such omission of unnecessary descriptions is intended to prevent obscuring the main concept of the present disclosure.

The advantages and features of the present disclosure, and the way to realize those advantages and features, will be apparent by referring in detail to the embodiments described below in conjunction with the accompanying drawings. However, the present disclosure is not limited to the embodiments set forth below, and may be implemented in various forms. The following embodiments are provided only to fully disclose the present disclosure and inform those skilled in the art of the scope of the present disclosure, and the present disclosure is limited only by the scope of the appended claims. Throughout the specification, the same or similar reference numerals denote the same or similar elements.

Here, it will be understood that each block of the flowchart illustration, and combinations of blocks in the flowchart illustration, may be implemented by computer program instructions. These computer program instructions may be provided to processors of general-purpose computers, special-purpose computers, or other programmable data processing apparatuses to produce a machine, so that instructions executed via the processors of the computer or other programmable data processing apparatuses create a device for implementing functions specified in one or more flowchart blocks. These computer program instructions may also be stored in a computer-usable or computer-readable memory, which may instruct computers or other programmable data processing apparatuses to behave in a specific manner, so that the instructions stored in the computer-usable or computer-readable memory produce an article which includes an instruction apparatus for performing functions specified in one or more flowchart blocks. The computer program instructions may also be loaded onto computers or other programmable data processing apparatuses to cause a series of operations to be performed on the computers or other programmable apparatuses to produce a computer-implemented process, so that instructions executed in the computers or other programmable apparatuses provide operations for implementing the functions specified in one or more flowchart blocks.

Also, each block of the flowchart may represent modules, segments, or portions of codes, including one or more executable instructions for implementing the specified logical function(s). It should also be noted that, in some alternative implementations, the functions noted in the blocks may occur out of the order. For example, two blocks shown in succession may, in fact, be executed substantially concurrently, or may be executed in the reverse order, depending upon the functions involved.

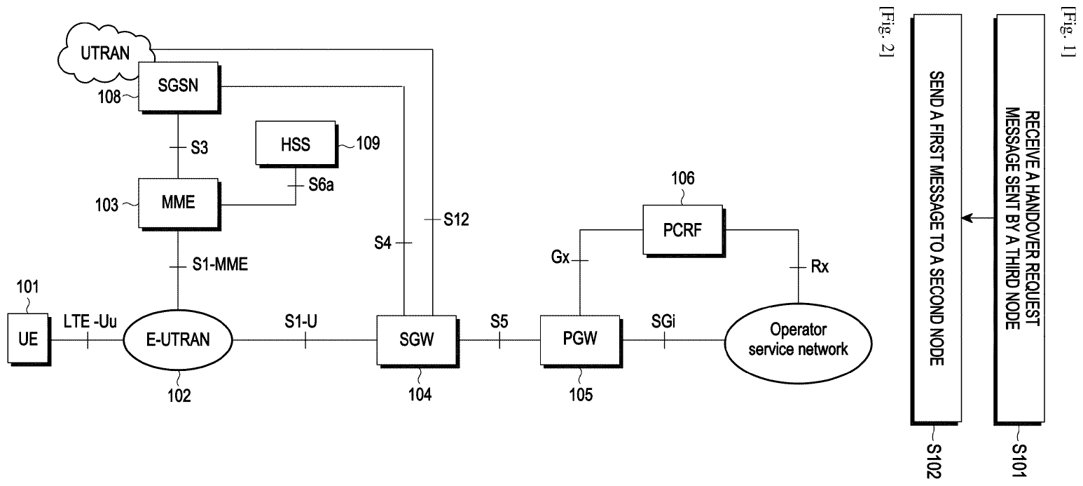

FIG. 1 to FIG. 17 discussed below and various embodiments for describing the principles of the present disclosure are only for illustration and should not be interpreted as limiting the scope of the disclosure in any way. Those skilled in the art will understand that the principles of the present disclosure can be implemented in any suitably arranged system or device.

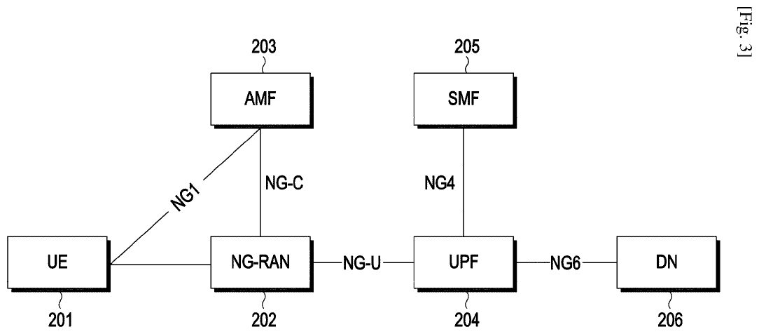

FIG. 2 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunication system (UMTS). A home subscriber server (HSS) 109 is a home subsystem of the UE, and is responsible for protecting user information including a current location of the user equipment, an address of a serving node, user security information, and packet data context of the user equipment, etc.

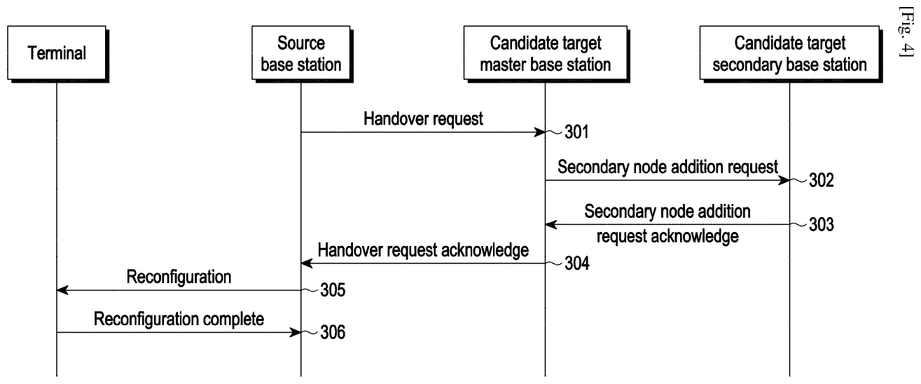

FIG. 3 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the CNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

The exemplary embodiments of the present disclosure are further described below in conjunction with the accompanying drawings.

The text and drawings are provided as examples only to help understand the present disclosure. They should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In the following embodiments, taking a 5G system as an example, a CU is taken as an example of an access network central unit, and a DU is taken as an example of a distributed unit. The method is applicable to corresponding entities in other systems.

In the present application, a node may be a complete base station (for example gNB, or eNB, or en-gNB, or ng-eNB), or a base station including a central unit and distributed units, or a base station including a central unit-control plane (CU-CP), a central unit-user plane (CU-UP) and distributed units.

In the present application, the name of a message is just exemplary, and other names may be used to name the message. The sequence number of messages only represents the name of messages, instead of the execution sequence of the messages.

In NR (New Radio access), DC (Dual Connectivity) is introduced to improve network performance and single-user traffic, and the performance of this technology is also being continuously improved. In DC, a UE will be connected to two nodes, one as the MN (Master Node), and the other one as the SN (Secondary Node). A group of cells serving the UE in the MN is called MCG (Master Cell Group), and a group of cells serving the UE in the SN is called SCG (Secondary Cell Group). The primary cell in the MCG is called PCell (Primary Cell), and the primary cell in the SCG is called PSCell (Primary SCG Cell). CG (Cell group) refers to a cell group, CG ID (Cell group ID) is the ID of the cell group, and SCG ID is the cell group ID of the SCG.

CHO (Conditional Handover) technology, the base station configures multiple candidate MCG primary cells PCells (that is, candidate PCells) and CHO execution conditions for a UE. The UE monitors the candidate PCells. When there is a candidate PCell that meets the CHO execution conditions, the UE selects an appropriate PCell to perform the handover, thereby improving the reliability and robustness of handover.

Under the mechanism of DC, conditional PSCell addition (CPA) and conditional PSCell change (CPC) technologies are introduced, which are collectively called conditional PSCell addition or change, to improve the reliability and robustness of PSCell addition and change, thus further improve the service throughput in the DC state. Conditional PSCell addition/change (CPAC) may also be represented by CPA/CPC.

Therefore, in order to further optimize the handover process and ensure the handover robustness and the service throughput, an enhanced handover method is needed to realize the effective mechanism of CHO and CPAC (CHO+CPAC for short). The present disclosure proposes CHO+CPAC handover mechanism management, so as to realize the effective utilization of the CHO+CPAC mechanism. The method further ensures the optimal selection of PSCells under the CHO mechanism, thereby ensuring the robustness and reliability of UE handover, and improving the system throughput while improving the handover performance.

In the present disclosure, the master base station in the DC state may also be called master node (MN). The secondary base station may also be called secondary node (SN). In the handover process, the source base station may also be called source node; the candidate target base station may also be called candidate target node, or candidate base station, or candidate node; and the new base station selected by the UE may be called target base station, or target node. When the source side is in the DC state, the source master base station may also be called source master node (S-MN), and the source secondary base station may also be called source secondary node (S-SN). When the target side is in the DC state, the base station to which the candidate PCell belongs is called candidate target master base station, or candidate target master node (T-MN), or candidate master base station, or candidate master node; the base station to which the candidate PSCell belongs is called candidate target secondary base station, or candidate target secondary node (T-SN), or candidate secondary base station, or candidate secondary node; during handover, the new master base station selected by the UE may be called target master base station, or target master node (T-MN); and the new secondary base station selected by the UE may be called target secondary base station, or target secondary node (T-SN).

The method provided by the present disclosure will be described below.

Specifically, as shown in FIG. 1, the present disclosure provides a method executed by a first node in a wireless communication system, including:
S101: receiving a handover request message sent by a third node, wherein the handover request message contains at least one of CHO trigger indication information and first indication information, and the first indication information indicates the maximum number of PSCells to prepare; and
S102: sending a first message to a second node, wherein the first message contains at least one of a candidate PCell ID or a configuration ID and second indication information, wherein the second indication information indicates the maximum number of PSCells to prepare.

Correspondingly, the present disclosure further provides a method executed by a second node in a wireless communication system, including:
receiving a first message sent by a first node, wherein the first message contains at least one of a candidate PCell ID or configuration ID and second indication information, wherein the second indication information indicates the maximum number of PSCells to prepare; and
sending a second message in response to the first message to the first node, wherein the second message contains a candidate PCell ID or a configuration ID, and candidate PSCell list information related to the the candidate PCell ID or configuration ID.

Correspondingly, the present disclosure further provides a method executed by a third node in a wireless communication system, including:
sending a handover request message to a first node, wherein the handover request message contains at least one of CHO trigger indication information and first indication information, and the first indication information indicates the maximum number of PSCells to prepare; and
receiving a handover request acknowledge message sent by the first node, wherein the handover request acknowledge message contains at least one of one or more cell radio network temporary identifiers (C-RNTIs) of a terminal or one or more cell group configuration IDs (CG configuration IDs), indication information of the number of candidate PSCells to prepare, CPAC evaluation maintenance indication information, CPAC monitoring range indication information, and monitoring timer.

Correspondingly, the present disclosure further provides a method executed by a terminal in a wireless communication system, including:
sending an eighth message to a first node, wherein the eighth message contains at least one of a CG configuration ID, PSCell list information, and measurement results.

Correspondingly, the present disclosure further provides a method executed by a sixth node in a wireless communication system, including:
receiving a tenth message sent by a fifth node, wherein the tenth message contains indirect data forwarding indication information; and
based on the indirect data forwarding indication information, a sixth node does not need to process the service data from a second node.

Correspondingly, the present disclosure further provides a method executed by an eighth node in a wireless communication system, including:
receiving a thirteenth message sent by a seventh node, wherein the thirteenth message contains indirect data forwarding indication information; and
based on the indirect data forwarding indication information, an eighth node does not need to process the service data from a ninth node.

In the various methods provided in the present disclosure, the first node may be a candidate master base station, the second node may be a candidate secondary base station, the third node may be a source base station or a source master base station, the fourth node may be a candidate master base station except for the first node, the fifth node may be the CU-CP of the candidate master base station, the sixth node may be the CU-UP of the candidate master base station, the seventh node may be the CU-CP of the source base station, and the eighth node may be the CU-UP of the source base station, and the ninth node may be the source secondary base station.

The method provided by the present disclosure will be specifically described below by specific embodiments.

The present disclosure includes several parts: configuration information indication method under the mechanism of CHO+CPAC; configuration information update indication method under the mechanism of CHO+CPAC; execution method under the mechanism of CHO+CPAC; and data forwarding method.

### Part I: Configuration Information Indication Method Under the Mechanism of CHO+CPAC

Under the mechanism of CHO+CPAC, in the handover preparation stage, the network will configure candidate PCells and candidate PSCells, as well as corresponding MCG resource configurations and SCG resource configurations, for the UE.

Since MN and SN jointly bear the service of the UE under DC, the MCG configurations corresponding to the PCells are associated to the SCG configurations corresponding to the PSCells. Therefore, under the mechanism of CHO+CPAC, the candidate target master base station and the candidate target secondary base station need to associate the candidate PCells with the candidate PSCells (that is, create a correspondence relation between the candidate PCells and the candidate PSCells), and then perform MCG resource configuration and SCG resource configuration for the UE respectively for the associated candidate PCells and candidate PSCells, so that the candidate T-MN and the candidate T-SN can jointly bear the service of the UE through DC, so as to support the mobility of the UE and also improve the throughput of the user.

When the source-side base station (source master base station or source base station) decides to adopt CHO handover, after the source MN selects a list of candidate PCells for the UE, for each candidate PCell, a handover request message will be sent to the candidate T-MN where the candidate PCell is located. If multiple candidate PCells belong to a same T-MN, then the source-side base station will send multiple handover request messages to the T-MN for different candidate PCells to request for handover. After receiving the handover request message, if the T-MN decides to adopt the DC technology and the CPAC mechanism, the T-MN will determine multiple candidate cells according to the measurement results provided from the source side, and send a request message to the candidate target secondary base station T-SN to which the candidate cells belong, to request the T-SN to configure SCG resources and select candidate PSCells for the UE.

Therefore, under the mechanism of CHO+CPAC, after receiving multiple handover request messages from the source base station for different candidate PCells, the T-MN may send multiple request messages to a same T-SN for different PCells, to request the T-SN to select candidate PSCells and perform SCG configuration for the same UE. The request message may be a “secondary node addition request message”. The T-SN feeds back the SCG configuration information for the UE to the T-MN by sending a request acknowledge message. The acknowledge message may be an “secondary node addition request acknowledge message”.

Different PCells have different states, for example load states, and different service bearing capabilities, so different PCells may bear different services for the UEs, and the corresponding MCG configurations will be different. Therefore, the SCGs configured by the T-SN for the UEs will be different. Moreover, corresponding to different SCG configuration requirements, the candidate PSCells selected by the T-SN for the UE may also be different. Therefore, when the T-SN sends multiple “request acknowledge messages” to feed back the SCG configuration information for the UE to the T-MN, the T-MN cannot effectively associate the received SCG configurations with the T-MN's MCG configurations. Therefore, the present invention proposes a configuration information indication method under the mechanism of CHO+CPAC, which can ensure the correspondence between the MCG configurations and the SCG configurations, and can associate a candidate PCell with a candidate PSCell or a list of candidate PSCells. Thus, when the T-MN and the T-SN exchange messages, the correctness of the transmitted configuration information is ensured.

In the “secondary node addition request message” sent by the T-MN to the T-SN and the “secondary node addition request acknowledge message” sent by the T-SN to the T-MN, “ID information” is added. Then, the T-SN can distinguish, according to the “ID information”, that each message is a request for the SCG configurations of the same UE, and the T-MN can associate the candidate PCells with the candidate PSCells according to the “ID information”, thereby associating the MCG configurations corresponding to the candidate PCells with the SCG configurations corresponding to the candidate PSCells. The MCG configuration information corresponding to the candidate PCells and the SCG configuration information corresponding to the candidate PSCells are provided to the UE to ensure the normal execution of CHO+CPAC.

The “ID information” may be set by at least one of the following methods.

In Method 1, the T-MN contains a candidate PCell ID in the “secondary node addition request message”. The candidate PCell ID is the candidate target cell ID carried in the handover request message sent by the source base station. The T-SN distinguishes multiple “secondary node addition request messages” from the T-MN through different PCell ID. After completing the selection of candidate PSCells and the corresponding SCG configuration, the T-SN contains the corresponding PCell ID in the “secondary node addition request acknowledge message” sent to the T-MN, and the T-MN can determine the “secondary node addition request message” corresponding to the acknowledge message. Through the PCell ID, the association/correspondence between the candidate PCell and the candidate PSCell or the list of candidate PSCells is realized, and thus the association/correspondence between candidate MCGs and candidate SCGs is realized.

In Method 2, the T-MN sets different values for the UE ID of the master node (that is, M-NG-RAN node UE XnAP ID) in the “secondary node addition request message” sent to T-SN. The T-SN distinguishes multiple “secondary node addition request messages” from the T-MN through different UE ID values. After completing the selection of candidate PSCells and the corresponding SCG configuration, the T-SN contains the corresponding UE ID values in the “secondary node addition request acknowledge message” sent to the T-MN, and the T-MN can determine the “secondary node addition request message” corresponding to the acknowledge message. Since the “secondary node addition request message” sent by the T-MN to the T-SN is for different candidate PCells, through the different UE ID values of master node, the association/correspondence between a candidate PCell and a candidate PSCell or a list of candidate PSCells is realized, and thus the association/correspondence between candidate MCGs and candidate SCGs is realized.

Method 3: “Configuration ID” are provided in the information element “conditional PSCell addition information request” in the “secondary node addition request message” sent by the T-MN, and other ID information may be further provided. The T-SN distinguishes multiple received “secondary node addition request messages” through different “configuration ID”. After completing the selection of candidate PSCells and the corresponding SCG configuration, the T-SN contains the corresponding “configuration ID” in the information element “conditional PSCell addition information acknowledgment” in the “secondary node addition request acknowledge message” sent to the T-MN, and the T-MN can determine the “secondary node addition request message” corresponding to the acknowledge message. Since the “secondary node addition request message” sent by the T-MN to the T-SN is for different candidate PCells, through the “configuration ID”, the association/correspondence between candidate a PCell and candidate a PSCell or a list of candidate PSCells is realized, and thus the association/correspondence between candidate MCGs and candidate SCGs is realized.

By adding the setting of “ID information”, candidate MCGs and candidate SCGs may be associated to ensure the correctness of the configuration information. Under the mechanism of CHO+CPAC, during the preparation, modification or update, and cancellation of conditional handover, the candidate master base station and secondary base station can efficiently and accurately perform resource allocation, modification or update, and release of the MCG and its associated SCG. This ensures the correctness of the transmitted configuration information, and further improves the efficiency of configuration information adjustment/update, thereby realizing effective management of configuration information and reducing network processing overhead.

Embodiment 1: A configuration information indication method under the mechanism of CHO+CPAC (that is, a method for indicating configuration information of candidate PCells and candidate PSCells) is provided. The network selects multiple candidate PCells/candidate target master base stations and multiple candidate PSCells/candidate target secondary base stations, and configures radio resources for the UE on the candidate target base stations and the candidate target secondary base stations. The candidate target master base stations and the candidate target secondary base stations associate the candidate PCells with the candidate PSCells or the list of candidate PSCells, and perform MCG resource configuration and SCG resource configuration for the UE respectively for the associated candidate PCells and candidate PSCells, so as to ensure that the candidate T-MNs and the candidate T-SNs jointly bear the services of the UE through DC, so as to support the mobility of the UE and also improve the throughput of the user.

The source base station (if the source side is in the DC state, it refers to the source master base station) selects a candidate PCell (candidate target master base station, that is, a candidate T-MN). The candidate T-MN selects a candidate T-SN for the UE according to the measurement result provided by the source base station, and performs MCG radio resource configuration for the UE on the candidate T-MN. The candidate T-SN selects a candidate PSCell for the UE, and performs SCG radio resource configuration for the UE according to the service configuration requirements provided by the candidate target T-MN.

Meanwhile, as the number of conditional configurations increases, the UE's capability requirements, such as measurement capabilities, will be increased. Therefore, under the mechanism of CHO+CPAC, it is also necessary to restrict the total number of conditional configurations of the UE, which may be realized by containing the maximum number of configurable candidate PSCells in the handover request message, or by other methods.

Therefore, under the mechanism of CHO+CPAC, in the handover preparation stage, the network needs to determine the configuration information for the mechanism of CHO+CPAC for the UE, and provide the configuration information to the UE. The configuration information for the mechanism of CHO+CPAC includes at least: candidate PCell list information, candidate PSCell list information, association relationship between candidate PCells and candidate PSCells, and corresponding MCG configuration information and SCG configuration information and/or the allowable maximum number of conditional configurations (for example, the maximum number of PSCells that can be prepared).

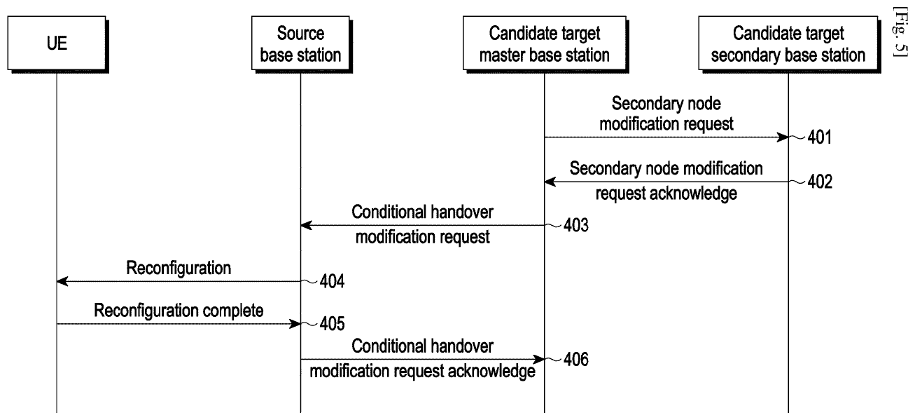

FIG. 4 shows a schematic diagram of the process of CHO+CPAC configuration, and a configuration information indication method under the mechanism of CHO+CPAC. In this process, the source side may be in single connectivity or dual connectivity state, which does not affect the whole process and configuration method. Therefore, only the source base station is used in FIG. 4, which collectively represents the source base station for the single connectivity state and the source master base station for the dual connectivity state.

In step 301, the source base station sends a handover request message or other messages to a candidate target master base station, which indicates that the handover is a CHO mechanism, to request the candidate target base station to use a PCell as a candidate cell for the UE handover and configure resources for the UE. The message contains at least one of the following information:
(1) UE ID information, indicating the ID of the UE at the source base station, that is, the source NG-RAN node UE XnAP ID allocated by the source base station.
(2) Identity of a candidate target cell, indicating the ID information of the candidate target cell for which the source base station requests handover, that is, the target cell global ID, which may be E-UTRA CGI or NR CGI. Under the mechanism of CHO+CPAC, it is a candidate primary cell (candidate PCell).
(3) CHO trigger indication information, indicating whether the handover process of the candidate target node UE uses the CHO mechanism.
(4) Indication of the maximum number of PSCells to prepare, indicating that the T-MN can use the CPAC mechanism to select a candidate PSCell for the UE, and indicating the maximum number of candidate PSCells that can be prepared for the candidate PCell if the T-MN uses the CPAC mechanism to select a PSCell. The indication of the maximum number of PSCells to prepare may be contained in the information element “conditional handover information request”, or may be contained in the handover request message as a separate information element. This avoids that the number of candidate PSCells configured by the candidate target base station exceeds the capability range of the UE.

In step 302, the candidate target master base station T-MN sends a secondary node addition request message to the candidate target secondary base station T-SN, to request the candidate target secondary base station T-SN to allocate resources for the UE. The candidate target secondary base station T-SN is instructed to allocate necessary resources for the CPAC process, and provide the measurement results to the T-SN for the T-SN to select a list of candidate PSCells.

The message contains at least one of the following information:
(1) UE ID information, indicating the ID of the UE at the candidate target master base station, that is, master NG-RAN node UE XnAP ID (M-NG-RAN node UE XnAP ID). The T-MN may set different values for the ID to distinguish different secondary node addition request messages, so as to realize the correspondence between the secondary node addition request message and the secondary node addition request acknowledge message.
(2) CPAC request information, which may be a CPA (Conditional PSCell Addition) information request. The information is used to instruct the candidate target secondary base station T-SN to allocate necessary resources for the CPAC process. The information element “CPA information request” contains at least one of the following information:
(2.1) maximum number of PSCells to prepare, indicating the maximum number of candidate PSCells that the secondary base station T-SN can provide; and
(2.2) estimated arrival probability, indicating the possibility that the UE will access the secondary node T-SN. The information may be set as a value between 1 and 100, and the higher the value, the higher the probability that the UE accesses the target candidate secondary node.
(3) Identity of the candidate PCell, that is, the PCell ID, which indicates the candidate PCell ID for which the source base station requests handover, which may be global NG-RAN cell ID. The candidate PCell ID is corresponding to the ID of the candidate target cell in step 301, i.e., the target cell global ID. That is, both indicate the same cell. The candidate PCell ID is used to distinguish different secondary node addition request messages, to realize the correspondence between the secondary node addition request message and the secondary node addition request acknowledge message, and to realize the association/correspondence between a candidate PCell and a candidate PSCell or a list of candidate PSCells, and thus to realize the association/correspondence between candidate MCGs and candidate SCGs.
(4) The container sent by the master base station to the secondary base station, that is, M-NG-RAN node to S-NG-RAN node container, containing cell group configuration information CG-ConfigInfo which contains the measurement results of the UE that are used for the selection of PSCells by the candidate target secondary base station.
(5) Configuration ID, which may be contained in the “conditional PSCell addition information request”, used to distinguish different secondary node addition request messages, to realize the correspondence between the secondary node addition request message and the secondary node addition request acknowledge message, to realize the association/correspondence between candidate a PCell and a candidate PSCell or a list of candidate PSCells, and thus to realize the association/correspondence between candidate MCGs and candidate SCGs.

The secondary node addition request message may be an S-NODE ADDITION REQUEST message, or an SGNB ADDITION REQUEST message, or other messages.

In step 303, the candidate target secondary base station T-SN sends a secondary node addition request acknowledge message to the candidate target master base station T-MN. From the measurement results provided by the T-MN obtained in step 302, the T-SN selects a list of candidate PSCells for the CPAC process, selects SCG SCells for each candidate PSCell, and configures SCG radio resources. Meanwhile, IDs of the list of candidate PSCells of the T-SN and the candidate PCell ID corresponding to the T-MN are indicated, so as to ensure the association between the list of candidate PSCells of the candidate T-SN and the PCells of the candidate T-MN, that is, the association between SCG resource configurations and MCG resource configurations. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID). The ID of the UE on the target master base station is the same as that received by the T-SN in step 302, so that the correspondence between the secondary node addition request message and the secondary node addition request acknowledge message is realized.
(2) CPAC request acknowledge information, indicating the candidate PSCell list information selected by the candidate target secondary base station for the UE. The acknowledge information may be an information element “CPA (Conditional PSCell Addition) information acknowledge”, containing the candidate PSCell list information selected by the candidate target secondary base station for the UE. The list information contains: PSCell ID, which may be NR CGI, containing information about the PLMN ID and the NR Cell ID.
(3) Container from the secondary node to the master node, containing a cell group candidate list message (CG-CandidateList) or a cell group configuration message (CG-Config), containing information such as the CG configuration corresponding to the candidate PSCells for the UE. The candidate target secondary node sends it to the candidate target master node in the form of container, and then the candidate target master node sends it to the UE.
(4) Data forwarding address information, indicating the transport layer address information for data forwarding, containing IP addresses and tunnel IDs. It is used to forward data to the target secondary base station.
(5) Identity of the candidate PCell, that is, the PCell ID, which indicates the candidate PCell ID for which the source base station requests handover, which may be global NG-RAN cell ID. The ID of the PCell is the same as that received by the T-SN in step 302, so that the correspondence between the secondary node addition request message and the secondary node addition request acknowledge message is realized, the association/correspondence between a candidate PCell and a candidate PSCell or a list of candidate PSCells is realized, and thus the association/correspondence between candidate MCGs and candidate SCGs is realized. In this way, effective management of configuration information is realized.
(6) Configuration ID, which may be contained in the “conditional PSCell addition information acknowledge”. The configuration ID is the same as that received by the T-SN in step 302, so that the correspondence between the secondary node addition request message and the secondary node addition request acknowledge message is realized, the association/correspondence between a candidate PCell and a candidate PSCell or a list of candidate PSCells is realized, and thus the association/correspondence between candidate MCGs and candidate SCGs is realized. In this way, effective management of configuration information is ensured.

The secondary node addition request acknowledge message may be an S-NODE ADDITION REQUEST ACKNOWLEDGE message, or an SGNB ADDITION REQUEST ACKNOWLEDGE message, or other messages.

In step 304, the candidate target master base station sends a handover request acknowledge message or other messages to the source base station. It is used to transmit CHO and CPAC related information configured by each candidate target master base station for the UE, and candidate PSCell information. The message contains at least one of the following information:
(1) UE ID information, containing the ID of the UE on the source base station (Source NG-RAN node UE XnAP ID) and the ID of the UE on the candidate target base station (Target NG-RAN node UE XnAP ID).
(2) Identity of the requested candidate target cell, indicating the ID of the target cell requested to handover corresponding to the acknowledge message, that is, the requested target cell ID, which may be E-UTRA CGI or NR CGI. In the DC state, the requested candidate target cell is the candidate PCell.
(3) Container from the candidate target base station to the source base station, that is, the target NG-RAN node to source NG-RAN node transparent container, containing a HandoverCommand message. The message contains information such as the CG configurations provided by the candidate target master base station for the UE in the candidate PCells and in the candidate PSCells (containing MCG and SCG configuration information), and the CPAC execution conditions configured for each candidate PSCell. The candidate target master base station sends it to the source base station in the form of container, and then the source base station sends it to the UE. It contains:
(3.1) Cell radio network temporary identifier (C-RNTI), used as the ID of the UE in the candidate PCell. Different MCG configurations provided by the candidate PCell for the UE may be distinguished by allocating different C-RNTIs to the UE. The C-RNTIs allocated by the T-MN to the UE in the candidate PCell will be contained in the MCG configurations.
(3.2) Cell group configuration ID (CellGroupConfigId). It is used to identify different MCG configurations provided by the PCell for the UE. After the UE selects a target PCell, it sends the ID to the T-MN to indicate the MCG configuration selected by the UE.

The T-MN may provide different MCG configurations for the UE in the PCell. If the UE is provided with different C-RNTIs in different MCG configurations, when the UE selects a target PCell to access, the T-MN may determine the MCG configuration selected by the UE according to the C-RNTI reported by the UE. Optionally, the T-MN may also determine the MCG configuration selected by the UE through the cell group configuration ID reported by the UE. The T-MN will use the same MCG configuration as the UE to ensure that the UE accesses the target base station for service transmission.
(4) Indication information of the number of PSCells to prepare, which may be “Number of PSCells to prepare”, used to indicate the number of candidate PSCells or candidate PSCell information actually configured for the requested candidate target cell, including IDs of one or more candidate PSCells, which may be CGI IDs or other IDs. After receiving the indication information, the source base station can determine the current number of conditional configurations for the UE, so as to determine whether to request conditional configurations of other candidate base stations for the UE in the subsequent configuration within the capability of the UE. In this way, within the capability of the UE, as many candidate cells as possible may be selected for the UE, which is beneficial for the UE to select an appropriate target cell to access.

In step 305, the source base station sends a reconfiguration message to a terminal UE, and sends CHO+CPAC configuration information to the UE. The message contains at least one of the following information:
(1) ID information of candidate Pcells, which may be conditional configuration ID condReconfigId or PCell ID or CGI or other ID information.
(2) Candidate PSCell list information, including ID information of each candidate PSCell, which may be conditional configuration ID condReconfigId or PSCell ID or CGI or other ID information. Wherein, if condReconfigId may be used, the candidate PSCell may use the same condReconfigId as the candidate Pcell, or use a different condRcconfigId.
(3) CHO execution conditions, indicating the conditions that the cell measurement results of candidate PCells need to meet when the UE executes CHO.
(4) CPAC execution conditions, indicating the conditions that the cell measurement results of candidate PSCells need to meet when the UE executes CPAC.
(5) CG configuration information, including MCG configuration information corresponding to each candidate PCell, and SCG configuration information corresponding to each candidate PSCcell. It may further include CPAC evaluation maintenance indication information and/or CPAC monitoring range indication information and/or monitoring timer T, and C-RNTI and/or CG configuration ID. The CG configuration information is sent by the candidate target base station to the source node in the form of container, and sent by the source base station to the UE.
(6) Correspondence information between candidate PCells and candidate PSCells, indicating the candidate PSCells or a list of candidate PSCells corresponding to the PCell.

The reconfiguration message may be an RRCReconfiguration message, or an RRC-ConnectionReconfiguration message, or other messages.

In step 306, the UE sends a reconfiguration complete message to the source base station, instructing the UE to complete configurations other than CHO+CPAC according to the configuration information sent by the source base station, and save the configuration information of CHO+CPAC.

The reconfiguration complete message may be an RRCReconfigurationComplete message, or an RRCConnectionReconfigurationComplete message, or other messages.

### Part II: Configuration Information Update Indication Method Under the Mechanism of CHO+CPAC

After the configuration of the mechanism of CHO+CPAC is completed, when the UE has not performed CHO+CPAC or CHO, that is, before the change of the PCell, due to the change of the load state of the T-MN and/or T-SN, or the change of the cell load state of the candidate PSCell, the candidate PSCell is not appropriate to be used as the candidate PSCell for the UE, or it is found that a new cell is appropriate to be used as the candidate PSCell for the UE, and the current candidate PSCell for the UE needs to be added. The change of the load state of the PSCell and the adjustment of the PSCell will affect the change of the candidate SCG configuration and the change of the associated candidate MCG configuration. Therefore, the present invention proposes a configuration information indication method on how to ensure the correlation between the updated/modified SCG configuration and the updated/modified MCG configuration. In this method, under the mechanism of CHO+CPAC, during the process of adding and canceling candidate PSCells or updating the SCG configuration corresponding to PSCells, the candidate master base station and the candidate secondary base station can efficiently and accurately complete the correlation between the updated/modified SCG configuration and the updated/modified MCG configuration. This ensures the correctness of configuration information, and also further improves the efficiency of configuration information adjustment/update, thereby realizing effective management of configuration information and reducing network processing overhead. Further, the updated configuration information is provided to the UE in time to ensure the UE handover success rate.

The candidate T-MN or candidate T-SN may trigger the change of the CPAC configuration, or the cancellation of candidate PSCells or the addition of candidate PSCells. The scenarios triggered by the candidate T-MN or candidate T-SN are given below.

Scenarios triggered by the candidate T-MN:
Scenario 1-1: the T-MN modifies the CPAC configuration of the candidate PSCells corresponding to the PCell;
Scenario 1-2: the T-MN cancels all PSCells corresponding to the PCell;
Scenario 1-3: the T-MN cancels some candidate PSCells corresponding to the PCell; and
Scenario 1-4: the T-MN cancels all candidate PSCells on the T-SN. Scenarios triggered by the candidate T-SN:
Scenario 2-1: the T-SN modifies the CPAC configuration of the candidate PSCells corresponding to the PCell;
Scenario 2-2: the T-SN cancels all PSCells corresponding to the PCell;
Scenario 2-3: the T-SN cancels some candidate PSCells corresponding to the PCell;
Scenario 2-4: the T-SN will add candidate PSCells corresponding to the PCell; and
Scenario 2-5: the T-SN cancels all candidate PSCells on the T-SN.

The above scenarios will all cause changes in the configuration information of CHO+CPAC, and the configuration information indication method will be described below by various embodiments. Wherein:

In Embodiment 2, for scenarios 1-1, 1-2 and 1-3, a configuration information update indication method under the mechanism of CHO+CPAC is proposed.

In Embodiment 3, for scenarios 1-2 and 1-4, another configuration information update indication method under the mechanism of CHO+CPAC is proposed.

In Embodiment 4, for scenarios 2-1, 2-2, 2-3 and 2-4, another configuration information update indication method under the mechanism of CHO+CPAC is proposed.

In Embodiment 5, for scenarios 2-2 and 2-5, another configuration information update indication method under the mechanism of CHO+CPAC is proposed.

### Embodiment 2: Configuration Information Update Indication Method Under the Mechanism of CHO+CPAC

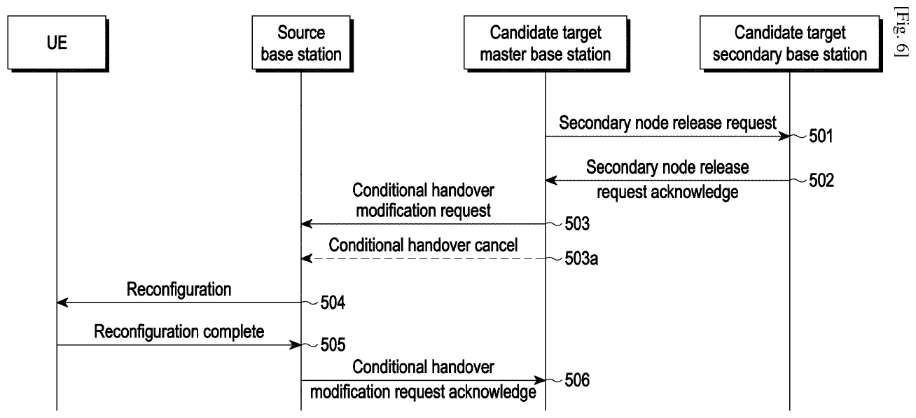

In scenarios 1-1, 1-2 and 1-3, the adjustment triggered by the T-MN will affect the modification of the SCG configuration and/or MCG configuration corresponding to the candidate PSCell for the UE, including the modification and release of the resource configuration of the user plane. Therefore, the configuration information of the mechanism of CHO+CPAC will be changed. Therefore, corresponding configuration update information needs to be provided to the source base station and the UE. FIG. 5 shows the flow of the configuration information update indication method. In this flow, the source side may be in single connectivity or dual connectivity state, which does not affect the description of the whole flow. Therefore, only the source base station is used in FIG. 5 and the method description, which collectively represents the source base station for the single connectivity state and the source master base station for the dual connectivity state.

In step 401, the candidate target master base station sends a secondary node modification request message to the candidate target secondary base station, to instruct to modify the configuration of the SCG corresponding to the PCell, including: adding, modifying or releasing user service plane resources. The message may also be used to instruct to cancel some/or all candidate PSCells corresponding to the PCell, or to adjust the maximum number of candidate PSCells. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. It is used to indicate to cancel some/or all candidate PSCells corresponding to the candidate PCell ID, or to modify/update the configuration of the candidate SCG corresponding to the candidate PCell ID.
(3) Information related to the user plane resource configuration, used to indicate information about user service plane resources that need to be updated.
(4) Information about the list of cells requested to be cancelled, containing the IDs of candidate PSCells requested to be cancelled, that is, the PSCell IDs, which may be NR CGIs or E-UTRA CGIs. The cell list information requesting cancellation may be used to explicitly indicate the identification of a candidate PSCell that the T-SN needs to cancel.
(5) Maximum number of PSCells to prepare, indicating the maximum number of candidate PSCells that the candidate target secondary base station T-SN can provide. The T-SN compares the newly received maximum number of PSCells to prepare with the previously stored maximum number of PSCells to prepare, and determines whether the number of candidate PSCells is increased or decreased so as to decide whether to cancel candidate PSCells or add new candidate PSCells. The maximum number of PSCells to prepare may implicitly instruct the candidate T-SN to cancel the PSCell, and the specific PSCell to be canceled is independently determined by the T-SN.
(6) Configuration ID, which may be contained in the information element “conditional PSCell addition information modification request”, used to indicate the cancellation of some/or all candidate PSCells corresponding to the configuration ID, or the modification/update of the candidate SCG configuration corresponding to the configuration ID.

The secondary node modification request message may be an S-NODE MODIFICATION REQUEST message, or an SENB MODIFICATION REQUEST message, or other messages.

In step 402, the candidate target secondary base station sends a secondary node modification request acknowledge message to the candidate target master base station, to provide modified/updated SCG configuration information, or information about candidate PSCells that accept cancellation. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. It is used to indicate to cancel some/or all candidate PSCells corresponding to the candidate PCell ID, or to modify/update the configuration of the candidate SCG corresponding to the candidate PCell ID. The candidate PCell ID is the same as that received in step 401.
(3) SCG radio resource information. The T-SN modifies/updates the SCG radio resource configuration according to the user plane resource configuration information requirements provided by the T-MN, and this information is contained in an SN RRC reconfiguration message.
(4) Information about the list of candidate PSCells, instructing information about candidate PSCells accepted by the T-SN to cancel or add. The candidate PSCells correspond to the PCell. The information about the candidate PSCells is provided in the form of list, which can directly provide the IDs of the canceled or added candidate PSCells, or provide a list of all candidate PSCells. The T-MN compares the list of all candidate PSCells with the original candidate PSCell list to determine the canceled or added cells. The IDs of the candidate PSCells are PSCell IDs, which may be NR CGIs or E-UTRA CGIs.
(5) Configuration ID, which may be contained in the information element “conditional PSCell addition information modification acknowledge”. It is used to indicate to the T-MN that the candidate PSCells corresponding to the configuration ID have been canceled or the SCG configuration of the candidate PSCells corresponding to the configuration ID has been updated. The configuration ID is used to indicate that some/all candidate PSCells corresponding to the configuration ID are canceled or the candidate SCG configuration corresponding to the configuration ID is modified/updated.

The secondary node modification request acknowledge message may be an S-NODE MODIFICATION REQUEST ACKNOWLEDGE message, or an SENB MODIFICATION REQUEST ACKNOWLEDGE message, or other messages.

In step 403, the candidate target master base station sends a conditional handover modification request to the source base station, to indicate to the source base station that the configuration information of the handover (under the mechanism of CHO+CPAC) has changed, so as to realize the handover configuration update/modification triggered by the target side, so as to ensure that the UE can access an appropriate target PSCell to ensure the handover success rate and the service transmission quality of the UE. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Candidate target cell ID information, indicating the ID of the candidate target cell whose handover configuration needs to be modified/updated, that is, the target cell ID, which may be E-UTRA CGI or NR CGI. Under the mechanism of CHO+CPAC, it is the ID candidate master cell (candidate PCell). The candidate target cell ID in the request corresponds to the candidate PCell ID in step 401, that is, both indicate the same cell. If the handover configurations of multiple candidate target cells need to be modified, then the candidate target cell ID information may also be provided in the form of list, containing the ID of each candidate target cell that needs the modification of handover configuration, that is, the target cell IDs, which may be E-UTRA CGIs or NR CGIs.
(3) Container from the candidate target base station to the source base station, that is, the target NG-RAN node to source NG-RAN node transparent container, containing a HandoverCommand message. The message contains the CG configuration information (containing MCG and SCG configuration information) corresponding to the candidate PCells and the candidate PSCells for the UE, and the CPAC execution conditions configured for each candidate PSCell. The candidate target master base station sends it to the source base station in the form of container, and then the source base station sends it to the UE. The message also contains the following information:
(3.1) Cell radio network temporary identifier (C-RNTI), used as the ID of the UE in the candidate PCell. Different MCG configurations provided by the candidate PCell for the UE may be distinguished by allocating different C-RNTIs to the UE. The C-RNTIs allocated by the T-MN to the UE in the candidate PCell will be contained in the MCG configurations.
(3.2) Cell group configuration ID (CellGroupConfigId). It is used to identify different MCG configurations provided by the PCell for the UE. If Method 1 is used, different C-RNTIs need to be allocated to the UE to distinguish the MCG configurations. If Method 2 is used, that is, different MCG configurations are distinguished through the CG configuration ID, then the same C-RNTI may be allocated to the UE in the candidate PCell.
(4) Indication information of the number of PSCells to prepare, which may be “Number of PSCells to prepare”, used to indicate the number of candidate PSCells actually configured for the requested candidate target cell. After receiving the indication information, the source base station can determine the current number of conditional configurations for the UE, so as to determine whether to request conditional configurations of other candidate base stations for the UE in the subsequent configuration within the capability of the UE. In this way, within the capability of the UE, as many candidate cells as possible may be selected for the UE, which is beneficial for the UE to select an appropriate target cell to access.
(5) CPAC evaluation maintenance indication information, which is used to determine whether the UE needs to perform CPAC monitoring on the candidate PSCells after completing the PCell change, when there is a candidate PCell that meets the CHO execution conditions and the candidate PSCells do not meet the CPAC execution conditions, or when there is a candidate PCell that meets the CHO execution conditions and the candidate PSCells meet the CPAC execution conditions, but the PCell and the PSCells do not match. The indication information may be of enumeration type. If it is “true”, then the UE will continue to perform CPAC monitoring on the candidate PSCells after completing the CHO. The CPAC evaluation maintenance indication information may be contained in the container from the candidate target base station to the source base station.
(6) CPAC monitoring range indication information, which is used to indicate that, after the UE selects a PCell as the target cell and completes the CHO handover, if it is still necessary to continue to perform CPAC monitoring on the candidate PSCells, whether candidate PSCells that need to be continuously monitored are PSCells corresponding to the selected target PCell, or all candidate PSCells configured by the network for the UE. The CPAC monitoring range indication information may be contained in the container from the candidate target base station to the source base station.
(7) Monitoring timer T. When the CPAC evaluation maintenance indication information is “true”, the timer is used to instruct the UE to monitor the time of CPAC. When the timer expires, if no PSCell meets the CPAC execution conditions, the UE needs to notify the network.

Through the setting of the CPAC evaluation maintenance indication information, the CPAC monitoring range indication information and the monitoring timer, the behavior of the UE is indicated, and the implementation of the handover mechanism of CHO+CPAC is controlled and managed, so as to ensure that the UE can complete the handover mechanism of CHO+CPAC to access an appropriate target PCell and PSCell, thus to ensure the service transmission quality of the UE and ensure the service throughput.

The conditional handover modification request message may be a CONDITIONAL HANDOVER MODIFICATION REQUEST message, or a CONDITIONAL HANDOVER MODIFICATION REQUIRED message, or other messages.

In step 404, the source base station sends a reconfiguration message to a terminal UE, and sends the updated CHO+CPAC configuration information to the UE. The message contains at least one of the following information:
(1) ID information of candidate Pcells, which may be conditional configuration ID condReconfigId or PCell ID or CGI or other ID information.
(2) Candidate PSCell list information, including ID information of each candidate PSCell, which may be conditional configuration ID condReconfigId or PSCell ID or CGI or other ID information. Wherein, if condReconfigId may be used, the candidate PSCell may use the same condReconfigId as the candidate Pcell, or use a different condReconfigId.
(3) CHO execution conditions, indicating the conditions that the cell measurement results of candidate PCells need to meet when the UE executes CHO.
(4) CPAC execution conditions, indicating the conditions that the cell measurement results of candidate PSCells need to meet when the UE executes CPAC.
(5) CG configuration information, that is, updated CG configuration information, including MCG configuration information corresponding to each candidate PCell, and SCG configuration information corresponding to each candidate PSCcell. The information may also include CPAC evaluation maintenance indication information and/or CPAC monitoring range indication information and/or monitoring timer T, and C-RNTI and/or CG configuration ID corresponding to the MCG configuration. The information is sent by the candidate target base station to the source node in the form of container, and sent by the source base station to the UE. The updated CG configuration information may be provided incrementally.
(6) Correspondence information between candidate PCells and candidate PSCells, indicating the candidate PSCell or a list of candidate PSCells corresponding to the PCell.

The reconfiguration message may be an RRCReconfiguration message, or an RRC-ConnectionReconfiguration message, or other messages.

In step 405, the UE sends a reconfiguration complete message to the source base station, instructing the UE to complete configurations other than CHO+CPAC according to the configuration information sent by the source base station, and save the configuration information of CHO+CPAC.

The reconfiguration complete message may be an RRCReconfigurationComplete message, or an RRCConnectionReconfigurationComplete message, or other messages.

In step 406, the source base station sends a conditional handover modification request acknowledge message to the candidate target master base station, which is used to indicate to the candidate target master base station that the UE has accepted the conditional handover modification request. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Candidate target cell ID information, indicating the IDs of the candidate target cells for which handover configuration modification is accepted by the UE, that is, the target cell IDs, which may be NR CGIs or E-UTRA CGIs. The candidate target cell ID information corresponds to the candidate target cell ID information in step 403, that is, both indicate the same cell.

The conditional handover modification request acknowledge message may be a CONDITIONAL HANDOVER MODIFICATION REQUEST ACKNOWLEDGE message, or a CONDITIONAL HANDOVER MODIFICATION CONFIRM message, or other messages.

### Embodiment 3: Another Configuration Information Update Indication Method Under the Mechanism of CHO+CPAC

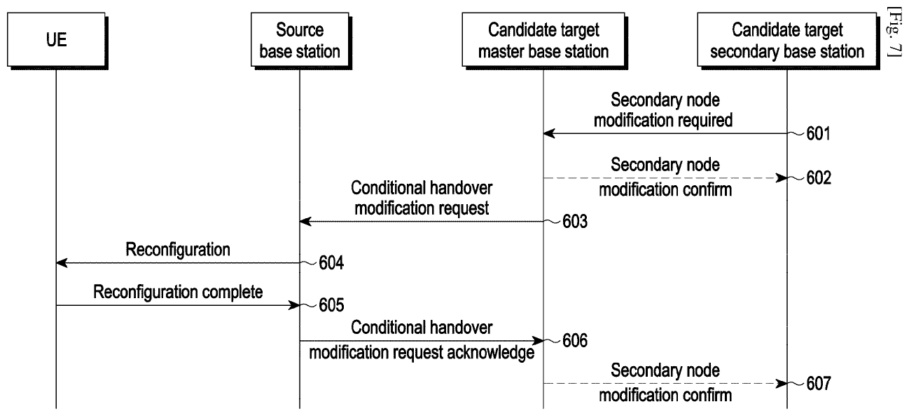

For scenarios 1-2 and 1-4, the present disclosure proposes another configuration information update indication method under the mechanism of CHO+CPAC, so that the candidate T-MN can cancel all candidate PSCells corresponding to the candidate PCell, or the candidate T-MN cancels all candidate PSCells on the T-SN. FIG. 6 shows the flow of the configuration information update indication method. In this flow, the source side may be in single connectivity or dual connectivity state, which does not affect the description of the whole flow. Therefore, only the source base station is used in FIG. 6 and the method description, which collectively represents the source base station for the single connectivity state and the source master base station for the dual connectivity state.

In step 501, the candidate target master base station sends a secondary node release request message to the candidate target secondary base station, to instruct the candidate target secondary base station to cancel the candidate PSCells for the UE, cancel the candidate PSCells corresponding to the PCell, or cancel all candidate PSCells. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. The candidate PCell ID is optional. If the candidate PCell ID is contained, the candidate target secondary base station is instructed to cancel all candidate PSCells corresponding to the candidate PCell ID. If the candidate PCell ID is not contained, the candidate target secondary base station is instructed to cancel all candidate PSCells for the UE.
(3) Configuration ID, which is optional. If the configuration ID is contained, the candidate target secondary base station is instructed to cancel all candidate PSCells corresponding to the configuration ID. If the configuration ID is not contained, the candidate target secondary base station is instructed to cancel all candidate PSCells for the UE.

The secondary node release request message may be an S-NODE RELEASE REQUEST message, or an SENB RELEASE REQUEST message, or other messages.

In step 502, the candidate target secondary base station sends a secondary node release request acknowledge message to the candidate target master base station, to indicate to the candidate target secondary base station that the candidate target secondary base station cancels the candidate PSCells, indicated in step 501, that need to be canceled. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. If the secondary node release request message in step 501 contains the candidate PCell ID, this message will also contain the ID, and it is the same as the candidate PCell ID received in step 501. This indicates to the T-MN that all candidate PSCells corresponding to the ID of the PCell have been canceled. If the secondary node release request message in step 501 does not contain the candidate PCell ID, this message also does not contain the candidate PCell ID, and this indicates to the T-MN that all candidate PSCells for the UE have been canceled.
(3) Configuration ID, which is optional. If the secondary node release request message in step 501 contains the configuration ID, this message also contains the configuration ID, and it is the same as the configuration ID received in step 501. This indicates to the T-MN that the candidate PSCells corresponding to the configuration ID have been canceled. If the secondary node release request message in step 501 does not contain the configuration ID, this message also does not contain the configuration ID, and indicates to the T-MN that all candidate PSCells for the UE have been canceled.

The secondary node release request acknowledge message may be an S-NODE RELEASE REQUEST ACKNOWLEDGE message or other messages.

The cancellation of candidate PSCells triggered by the T-MN may be due to the following two situations:
Situation 1: the candidate target master base station cancels only the candidate PSCells. In this case, due to the cancellation of the PSCells, the MCG configuration corresponding to the corresponding candidate PCell will also change, resulting in the modification of the configuration information under the mechanism of CHO+CPAC. Therefore, the candidate target master base station needs to send a conditional handover modification request message to the source base station, to indicate the change of the configuration information under the mechanism of CHO+CPAC. In this case, steps 503-506 will be executed. Steps 503-506 are the same as steps 403-406 and will not be repeated here.
Situation 2: the candidate target master base station cancels the candidate PCell. When the candidate target master base station finds that the previously selected candidate cell is no longer appropriate as the candidate PCell for the UE, it will trigger the cancellation of the PCell, resulting in the cancellation of the candidate PSCells associated with the candidate PCell. Therefore, it is necessary to instruct the UE to release the configuration information of the corresponding PCells and PSCells. In this case, steps 503a-505 will be executed.

In step 503a, the candidate target master base station sends a conditional handover cancel message to the source base station. The message is used to indicate that the candidate target master base station will cancel the candidate PCell, and also indicate that the PSCells corresponding to the candidate PCell will also be cancelled. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Information about the list of cells to be cancelled, containing the PCell IDs of candidate cells requested to be cancelled, that is, the target cell IDs, which may be NR CGIs or E-UTRA CGIs.

The cancellation of the candidate PCell will cause the configuration information of the mechanism of CHO+CPAC to be updated, so the updated configuration information of the mechanism of CHO+CPAC needs to be sent to the UE. Steps 504 and 505 are performed. Steps 504-505 are the same as steps 404-405, and will not be repeated here.

### Embodiment 4: Another Configuration Information Update Indication Method Under the Mechanism of CHO+CPAC

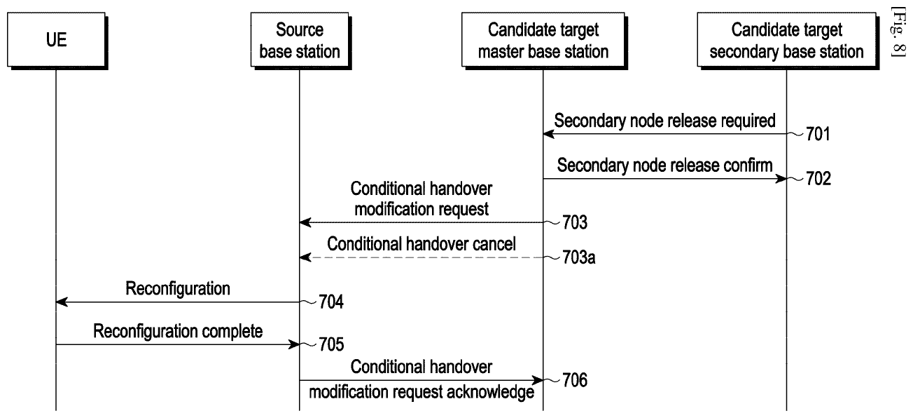

In scenarios 2-1, 2-2, 2-3 and 2-4, the adjustment triggered by the T-SN will affect the modification of the SCG configuration and/or MCG configuration corresponding to the candidate PSCell for the UE, including the modification and release of the resource configuration of the user plane. Therefore, the configuration information of the mechanism of CHO+CPAC will be changed. Therefore, corresponding configuration update information needs to be provided to the source base station and the UE. FIG. 7 shows the flow of the configuration information update indication method. In this flow, the source side may be in single connectivity or dual connectivity state, which does not affect the description of the whole flow. Therefore, only the source base station is used in FIG. 7 and the method description, which collectively represents the source base station for the single connectivity state and the source master base station for the dual connectivity state.

In step 601, the candidate target secondary base station sends a secondary node modification required message to the candidate target master base station, to provide the update configuration of the SCG corresponding to candidate PSCells associated to the PCell, including: modifying or releasing user service plane resources. The message may also be used to instruct to cancel some/or all candidate PSCells corresponding to the PCell, or to add new candidate PSCells. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. It is used to indicate to cancel some/or all candidate PSCells corresponding to the candidate PCell ID, or to add candidate PSCells corresponding to the candidate PCell ID, or to modify/update the configuration of the candidate SCG corresponding to the candidate PCell ID.
(3) SCG configuration information, which provides updated SCG radio resource configuration information.
(4) CPAC information required. It contains information about the list of candidate PSCells, including candidate PSCell IDs, which may be NR CGIs or E-UTRA CGIs. If a candidate PSCell is canceled, the PSCell ID will not be contained in the list, and if there is a new candidate PSCell, then the PSCell ID will be contained in the list.
(5) Configuration ID, which may be contained in the CPAC information required. It is used to indicate to cancel some/or all candidate PSCells corresponding to the configuration ID, or add candidate PSCells corresponding to the configuration ID, or to modify/update the configuration of the candidate SCG corresponding to the configuration ID.

The secondary node modification required message may be an S-NODE MODIFICATION REQUIRED message, or an SENB MODIFICATION REQUIRED message, or other messages.

In step 602, the candidate target master base station sends a secondary node modification confirm message to the candidate target secondary base station, indicating that it accepts the SCG configuration update, or accepts the canceled candidate PSCell information, and completes the corresponding configuration update. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. It is used to indicate the acknowledgement to cancel some/or all candidate PSCells corresponding to the candidate PCell ID, or add candidate PSCells corresponding to the candidate PCell ID, or to modify/update the configuration of the candidate SCG corresponding to the candidate PCell ID.
(3) Configuration ID, which is used to indicate the acknowledgement to cancel some/or all candidate PSCells corresponding to the configuration ID, or to add candidate PSCells corresponding to the configuration ID, or to modify/update the configuration of the candidate SCG corresponding to the configuration ID.

The candidate target master base station may send a secondary node modification confirm message to the candidate target secondary base station in step 602 or in step 607. If it is sent in step 607, it means that the candidate target secondary base station is notified after the UE accepts the new configuration update of the mechanism of CHO+CPAC.

The secondary node modification confirm message may be an S-NODE MODIFICATION CONFIRM message, or an SENB SENB MODIFICATION CONFIRM message, or other messages.

Steps 603-606 are the same as steps 403-406, and will not be repeated here.

### Embodiment 5: Another Configuration Information Update Indication Method Under the Mechanism of CHO+CPAC

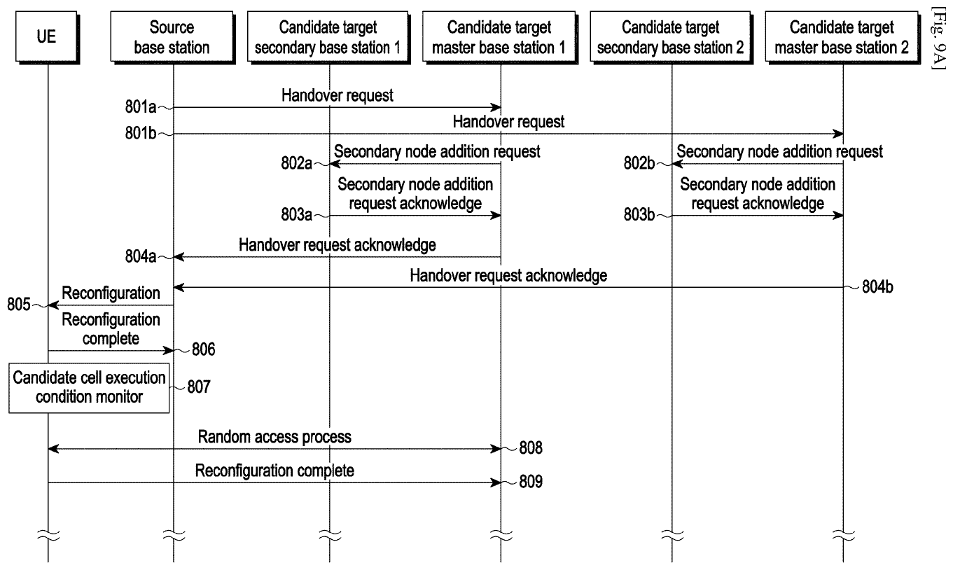

For scenarios 2-2 and 2-5, the present disclosure proposes another configuration information update indication method under the mechanism of CHO+CPAC, so that the candidate T-SN can cancel all candidate PSCells corresponding to the candidate PCell, or the candidate T-SN cancels all candidate PSCells on the T-SN. FIG. 8 shows the flow of the configuration information update indication method. In this flow, the source side may be in single connectivity or dual connectivity state, which does not affect the description of the whole flow. Therefore, only the source base station is used in FIG. 8 and the method description, which collectively represents the source base station for the single connectivity state and the source master base station for the dual connectivity state.

In step 701, the candidate target secondary base station sends a secondary node release required message to the candidate target master base station, to indicate to the candidate target master base station that the candidate target secondary base station cancels the candidate PSCells for the UE, and to cancel the candidate PSCells corresponding to the PCell, or cancel all candidate PSCells. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. The candidate PCell ID is optional. If the candidate PCell ID is contained, the candidate target secondary base station is instructed to cancel all candidate PSCells corresponding to the candidate PCell ID. If the candidate PCell ID is not contained, the candidate target secondary base station is instructed to cancel all candidate PSCells for the UE.
(3) Configuration ID. It is optional. If the configuration ID is contained, the candidate target secondary base station is instructed to cancel all candidate PSCells corresponding to the configuration ID. If the configuration ID is not contained, the candidate target secondary base station is instructed to cancel all candidate PSCells for the UE.

The secondary node release required message may be an S-NODE RELEASE REQUIRED message, or an SENB RELEASE REQUIRED message, or other messages.

In step 702, the candidate target master base station sends a secondary node release confirm message to the candidate target secondary base station, to indicate to the candidate target secondary base station that information about canceling the candidate PSCells has been received. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) The candidate PCell ID, that is, the PCell ID, which may be the global NG-RAN cell ID. The candidate PCell ID is optional. If the candidate PCell ID is contained, the candidate target master base station is instructed to acknowledge the request to cancel the candidate PSCells corresponding to the PCell. If the candidate PCell ID is not contained, the candidate target master base station is instructed to acknowledge the request to cancel all candidate PSCells for the UE.
(3) Configuration ID. It is optional. If the secondary node release request message in step 701 contains the configuration ID, then this message also contains the configuration ID and it is the same as the configuration ID received in step 701. This indicates to the T-SN that the request to cancel the candidate PSCells corresponding to the configuration ID has been acknowledged. If the secondary node release request message in step 701 does not contain the configuration ID, this message also does not contain the configuration ID, and this indicates to the T-SN that the request to cancel all candidate PSCells for the UE has been acknowledged.

The secondary node release confirm message may be an S-NODE RELEASE CONFIRM message, or an SENB RELEASE CONFIRM message, or other messages. The cancellation of candidate PSCells triggered by the T-SN may cause the following two situations:
Situation 1: the candidate target master base station cancels only the candidate PSCells. In this case, due to the cancellation of the PSCells, the MCG configuration corresponding to the associated candidate PCell will also change, resulting in the modification of the configuration information under the mechanism of CHO+CPAC. Therefore, the candidate target master base station needs to send a conditional handover modification request message to the source base station, to indicate the change of the configuration information under the mechanism of CHO+CPAC. In this case, steps 703-706 will be executed. Steps 703-706 are the same as steps 403-406 and will not be repeated here.
Situation 2: the candidate target master base station cancels the candidate PCell. When the T-SN cancels the candidate PSCells, it will result in the change of the MCG configuration corresponding to the associated PCell. As a result, the T-MN may decide to cancel one or more corresponding PCells because it is unable to accept the changed MCG configuration. Therefore, it is necessary to instruct the UE to release the configuration information of the corresponding PCells and PSCells. In this case, steps 703a-705 will be executed. Steps 704-705 are the same as steps 404-405 and will not be repeated here.

In step 703a, the candidate target master base station sends a conditional handover cancel message to the source base station. The message is used to indicate that the candidate target master base station will cancel the candidate PCell, and also indicate that the PSCells corresponding to the candidate PCell will also be cancelled. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Information about the list of cells to be cancelled, containing the cell IDs of candidate cells requested to be cancelled, that is, the target cell IDs, which may be NR CGIs or E-UTRA CGIs.

The cancellation of the candidate PCell will cause the configuration information of the mechanism of CHO+CPAC to be updated, so the updated configuration information of the mechanism of CHO+CPAC needs to be sent to the UE. Steps 704 and 705 are performed. Steps 704-705 are the same as steps 404-405, and will not be repeated here.

### Part III: Execution Method Under the Mechanism of CHO+CPAC

The CHO+CPAC configuration includes the CHO execution conditions for the candidate PCells and the CPAC execution conditions for the candidate PSCells. After the network configures CHO+CPAC for the UE, the UE will measure the candidate PCells and candidate PSCells to monitor whether the CHO execution conditions and CPAC execution conditions are met. If there is a candidate PCell that meets the CHO execution conditions and a candidate PSCell that meets the CPAC execution conditions, and the PCell is associated with the PSCell, then the UE can select the PCell that meets the CHO execution conditions and the PSCell that meets the CPAC execution conditions as the target PCell and the target PSCell, and performs configuration change according to the MCG and SCG configurations obtained in the handover preparation stage to execute the CHO+CPAC process.

However, if there is a candidate PCell that meets the CHO execution conditions, but there is no candidate PSCell that meets the CPAC execution conditions; or if there is a candidate PSCell that meets the CPAC execution conditions, but there is no candidate PCell that meets the CHO execution conditions; or if there is a candidate PCell that meets the CHO execution conditions and there is a candidate PSCell that meets the CPAC execution conditions, but the candidate PCell that meets the CHO execution conditions is not associated with the candidate PSCell that meets the CPAC execution conditions, the UE may not be able to perform CHO+CPAC handover, and may not be able to access an appropriate target PCell and target PSCell, which affects the handover performance. The present invention proposes a CHO+CPAC execution method to ensure that the UE can quickly access the target cell, to realize the CHO+CPAC handover, so as to ensure the continuity and throughput requirements of service transmission.

First, the possible scenarios are divided into the following three categories:
category 1, the CHO execution conditions are met, but the CPAC execution conditions are not met;
category 2, the CHO execution conditions are met and the CPAC execution conditions are met, but the PCell and the PSCell are not associated, that is, the MCG and SCG configurations are not associated; and
category 3, the CPAC execution conditions are met, but the CHO execution conditions are not met.

The CHO+CPAC execution method needs to consider the following two factors:
Factor 1: If the CHO execution conditions are met but the CPAC execution conditions are not met, or the CPAC execution conditions are met but the PSCell and the PCell are not associated, it determines whether to execute CHO first, or wait for the CPAC execution conditions to be met. Wherein:
1. If CHO is executed, it determines whether the UE needs to continue to monitor the candidate PSCells for the CPAC execution conditions.
2. If it is needed to continue to monitor the candidate PSCells for the CPAC execution conditions, it determines whether the monitored PSCells are the candidate PSCells corresponding to the PCell, or all the candidate PSCells.
Factor 2: If the CPAC execution conditions are met but the CHO execution conditions are not met, or the CHO execution conditions are met but the PCell and the PSCell do not correspond to each other, it determines whether to report information about the PSCells that meet the CPAC execution conditions.

In the following, different embodiments will be used to describe how the execution method under the mechanism of CHO+CPAC enables the UE to access an appropriate PCell and PSCell in different scenarios.

### Embodiment 7: An Execution Method Under the Mechanism of CHO+CPAC is Provided

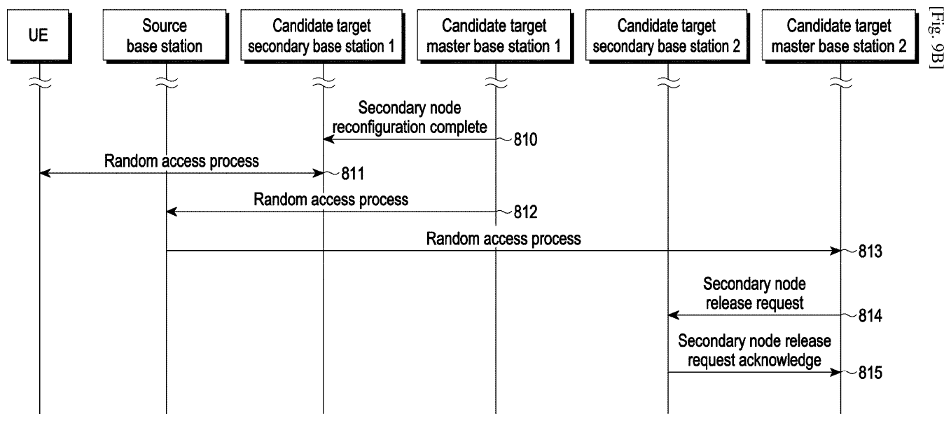

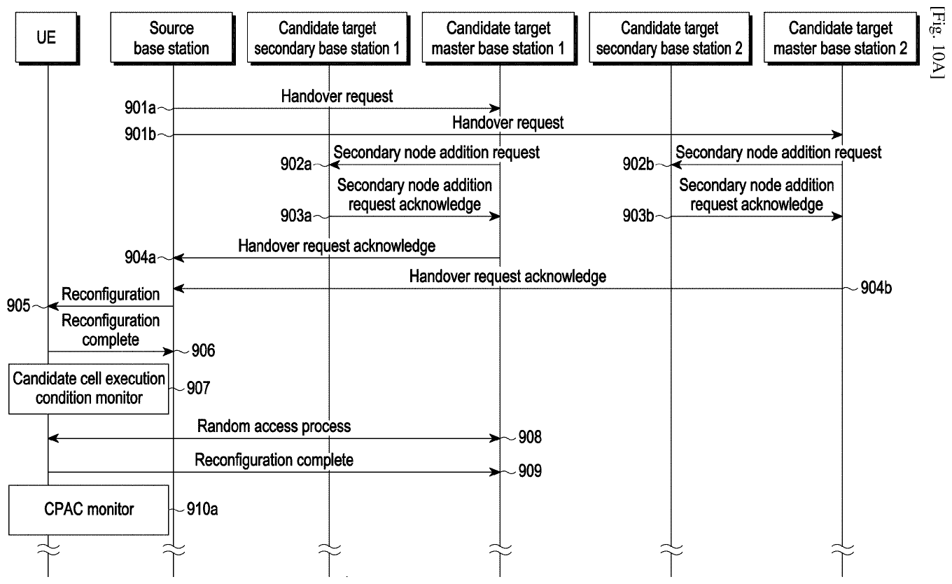

This process shows how the UE accesses the target PCell and the target PSCell when the corresponding PCell and PSCell meet the CHO execution conditions and the CPAC execution conditions respectively. FIGS. 9A and 9B show the schematic diagram of the process. In this flow, the source side may be in single connectivity or dual connectivity state, which does not affect the description of the whole flow. Therefore, only the source base station is used in FIGS. 9A and 9B and the method description, which collectively represents the source base station for the single connectivity state and the source master base station for the dual connectivity state.

In step 801a/b, the source base station sends a handover request message or other messages to the candidate target master base station. When the CHO mechanism is used, the source base station selects one or more candidate PCells for the UE, and sends a handover request message to each candidate target master base station for each candidate PCell, to request the candidate target master base station to prepare handover resources for the UE. The message contains at least one of the following information:
(1) UE ID information, indicating the ID of the UE at the source base station, that is, the source NG-RAN node UE XnAP ID allocated by the source base station.
(2) Identity of a candidate target cell, indicating the ID information of the candidate target cell for which the source base station requests handover, that is, the target cell global ID, which may be E-UTRA CGI or NR CGI.
(3) CHO trigger indication information, indicating whether the handover process of the candidate target node UE uses the CHO mechanism.
(4) Indication of the maximum number of PSCells to prepare, indicating the maximum number of candidate PSCells that can be prepared for the candidate PCell if the T-MN uses the CPAC mechanism to select a PSCell. The indication of the maximum number of PSCells to prepare may be contained in the information element “conditional handover information request”, or may be contained in the handover request message as a separate information element.

In step 802a/b, the candidate target master base station sends a secondary node addition request message to the candidate target secondary base station, to request the candidate target secondary base station to allocate resources for the UE. The candidate target secondary base station is instructed to allocate necessary resources for the CPAC process, and provide the measurement results to the T-SN for the T-SN to select a list of candidate PSCells. The message contains at least one of the following information:
(1) UE ID information, indicating the ID of the UE at the candidate target master base station, that is, master NG-RAN node UE XnAP ID (M-NG-RAN node UE XnAP ID). The T-MN may set different values for the ID to distinguish different secondary node addition request messages, so as to realize the correspondence between the secondary node addition request message and the secondary node addition request acknowledge message.
(2) CPAC request information, which may be a CPA (Conditional PSCell Addition) information request. The information is used to instruct the candidate target secondary base station T-SN to allocate necessary resources for the CPAC process. The CPA information request information element contains:
(2.1) maximum number of PSCells to prepare, indicating the maximum number of candidate PSCells that the secondary base station T-SN can provide; and
(2.2) estimated arrival probability, indicating the possibility that the UE will access the secondary node T-SN. The information may be set as a value between 1 and 100, and the higher the value, the higher the probability that the UE accesses the target candidate secondary node.
(3) Identity of the candidate PCell, that is, the PCell ID, which indicates the candidate PCell ID for which the source base station requests handover, which may be global NG-RAN cell ID. The candidate PCell ID is corresponding to the ID of the candidate target cell in step 801, i.e., the target cell global ID. That is, both indicate the same cell. Different secondary node addition request messages are distinguished through the candidate PCell ID, so as to realize the correspondence between the secondary node addition request message and the secondary node addition request acknowledge message. The association/correspondence between the candidate PCells and the candidate PSCells or the list of candidate PSCells is realized, and thus the association/correspondence between the candidate MCG and the candidate SCG is realized.
(4) The container sent by the master base station to the secondary base station, that is, M-NG-RAN node to S-NG-RAN node container, containing cell group configuration information CG-ConfigInfo which contains the measurement results from the UE that are used for the selection of PSCells by the candidate target secondary base station.
(5) Configuration ID, which may be contained in the “conditional PSCell addition information request”, used to distinguish different secondary node addition request messages, to realize the correspondence between the secondary node addition request message and the secondary node addition request acknowledge message, to realize the association/correspondence between a candidate PCell and a candidate PSCell or a list of candidate PSCells, and thus to realize the association/correspondence between candidate MCGs and candidate SCGs.
(6) Identity of the source node and the ID information of the UE on the source node. The ID of the source node, that is, source M-NG-RAN node ID, may be Global NG-RAN Node ID. The ID of the UE on the source node, that is, source M-NG-RAN node UE XnAP ID, may be NG-RAN node UE XnAP ID. In the CHO+CPAC configuration preparation stage, different candidate T-MNs may select the same T-SN as the candidate target secondary nodes of the UE, and request the T-SN to configure SCGs for the UE. The ID will be used as the ID of the UE, which is used for the T-SN to determine whether SN addition request messages are SCG configuration requests for the same UE when receiving them from different T-MNs. This can prevent the T-SN from establishing multiple communication contexts for the same UE to perform multiple resource configurations, and thus can prevent the T-SN from reserving multiple resources for the same UE, and also reduce the configuration processing of the T-SN.

The secondary node addition request message may be an S-NODE ADDITION REQUEST message, or an SGNB ADDITION REQUEST message, or other messages.

In step 803a/b, the candidate target secondary base station T-SN sends a secondary node addition request acknowledge message to the candidate target master base station T-MN. From the measurement results provided by the T-MN obtained in step 802, the T-SN selects a list of candidate PSCells for the CPAC process, selects SCG SCells for each candidate PSCell, and configures SCG radio resources. Meanwhile, IDs of the list of candidate PSCells of the T-SN and the candidate PCell ID corresponding to the T-MN are indicated, so as to ensure the association between the list of candidate PSCells of the candidate T-SN and the PCells of the candidate T-MN, that is, the association between SCG resource configurations and MCG resource configurations. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID). The ID of the UE on the target master base station is the same as that received by the T-SN in step 802, so that the correspondence between the secondary node addition request message and the secondary node addition request acknowledge message.
(2) CPAC request acknowledge information, indicating the candidate PSCell list information selected by the candidate target secondary base station for the UE. The acknowledge information may be an information element “CPA (Conditional PSCell Addition) information acknowledge”, containing the candidate PSCell list information selected by the candidate target secondary base station for the UE. The list information contains: PSCell ID, which may be NR CGI, containing information about the PLMN ID and the NR Cell ID.
(3) Container from the secondary node to the master node, containing a cell group candidate list message (CG-CandidateList) or a cell group configuration message (CG-Config), containing information such as the SCG configuration corresponding to the candidate PSCells for the UE. The candidate target secondary node sends it to the candidate target master node in the form of container, and then the candidate target master node sends it to the UE.
(4) Data forwarding address information, indicating the transport layer address information for data forwarding, containing IP addresses and tunnel IDs. It is used to forward data to the target secondary base station.
(5) Identity of the PCell, that is, the PCell ID, which indicates the candidate PCell ID for which the source base station requests handover, which may be global NG-RAN cell ID. The ID of the PCell is the same as that received by the T-SN in step 802, so that the correspondence between the secondary node addition request message and the secondary node addition request acknowledge message is realized, the association/correspondence between a candidate PCell and a candidate PSCell or a list of candidate PSCells is realized, and thus the association/correspondence between candidate MCGs and candidate SCGs is realized. In this way, effective management of configuration information is realized.
(6) Configuration ID, which may be contained in the “conditional PSCell addition information acknowledge”. The configuration ID is the same as that received by the T-SN in step 802, so that the correspondence between the secondary node addition request message and the secondary node addition request acknowledge message is realized, the association/correspondence between candidate a PCell and a candidate PSCell or a list of candidate PSCells is realized, and thus the association/correspondence between candidate MCGs and candidate SCGs is realized. In this way, effective management of configuration information is ensured.

The secondary node addition request acknowledge message may be an S-NODE ADDITION REQUEST ACKNOWLEDGE message, or an SGNB ADDITION REQUEST ACKNOWLEDGE message, or other messages.

In step 804a/b, the candidate target master base station sends a handover request acknowledge message or other messages to the source base station. It is used to transmit CHO and CPAC related information configured by each candidate target master base station for the UE, and candidate PSCell information. Indication information may also be indicated, which indicates whether to continue to monitor the candidate PSCells for CPAC after the UE executes the CHO handover. In steps 802a-803a, the candidate target secondary base station 1 configures multiple candidate PSCells for the UE. However, the load conditions of the candidate PSCells are different, so the corresponding SCG resource configurations are different. Assuming that the T-MN1 selects PCell1 as the candidate PCell for the UE, and the candidate PSCell1 and PSCell2 selected by the T-SN1 as the candidate PSCells for the UE. Then, the SCG configurations corresponding to the PSCell1 and PSCell2 are SCG1 and SCG2 respectively. Due to the different SCG configurations, the candidate PCell1 will form two MCG configurations for the SCG configurations corresponding to the two candidate PSCells (PSCell1 and PSCell2), that is, MCG1 and MCG2. Therefore, the T-MN1 and the T-SN1 provide the UE with two resource configurations for the candidate PCell1, the configuration provided by the PCell1 and PSCell1 for the UE is MCG1+SCG1, and the configuration provided by the PCell1 and PSCell2 for the UE is MCG2+SCG2. Therefore, when the UE selects the PCell to access the target master base station T-MN1, the T-MN1 needs to know which configuration the UE uses, and thus it is needed to distinguish the two configurations. There are two ways to distinguish the two configurations.

The first way is to distinguish the two configurations through the cell radio network temporary identifier, that is, C-RNTI. The T-MN1 allocates different MCG configurations to the UE in the candidate PCell1, and then the T-MN1 allocates different C-RNTIs to the UE in the candidate PCell1. That is, when the configuration is MCG1, the T-MN1 allocates C-RNTI1 to the UE, and when the configuration is MCG2, the T-MN1 allocates C-RNTI2 to the UE. When the UE selects PCell1 as the target PCell, if the UE chooses to use MCG1 configuration, then when the UE accesses the PCell1 to perform a random access process, the UE will send C-RNTI1 to the T-MN1. the T-MN1 can determine that the UE uses the configuration MCG1 according to the received C-RNTI1, and the T-MN1 also uses the configuration MCG1 to perform data transmission with the UE. The UE may send the C-RNTI to the target T-MN through a message 3 (Msg3) or message A (MSGA) in the random access process or a reconfiguration complete message.

The second way is to distinguish the two configurations through the CG configuration ID, that is, cell group configuration ID (CellGroupConfigId), which is integer type. The different MCG configurations configured for the UE in the PCell1 are identified by the value of CellGroupConfigId. Therefore, when PCell1 corresponds to multiple MCG configurations, T-MN1 will provide UE with different CellGroup-ConfigIds to distinguish different MCG configurations. For example, when the value of CellGroupConfigId is 1, it indicates that the MCG configuration is MCG1, and when the value of CellGroupConfigId is 2, it indicates that the MCG configuration is MCG2. When the UE selects PCell1 as the target PCell, if the UE chooses to use the configuration MCG1, then the UE contains CellGroupConfigId in the message sent to the T-MN1 and the value of CellGroupConfigId is 1. The T-MN1 can determine that the UE uses the configuration MCG1 according to the received CellGroupConfigId, and the T-MN1 also uses the configuration MCG1 to perform data transmission with the UE. The message sent by the UE to the T-MN1 may be an RRC reconfiguration complete message, or a message 3 (Msg3) or message A (MSGA) in the random access process.

The handover request acknowledge message contains at least one of the following information:
(1) UE ID information, containing the ID of the UE on the source base station (Source NG-RAN node UE XnAP ID) and the ID of the UE on the candidate target base station (Target NG-RAN node UE XnAP ID).
(2) Identity of the requested candidate target cell, indicating the ID of the target cell requested to handover corresponding to the acknowledge message, that is, the requested target cell ID, which may be E-UTRA CGI or NR CGI. In the DC state, the requested candidate target cell is the candidate PCell.
(3) Container from the candidate target base station to the source base station, that is, the target NG-RAN node to source NG-RAN node transparent container, containing a HandoverCommand message. The message contains the CG configurations provided by the candidate target master base station for the UE in the candidate PCells and in the candidate PSCells (containing MCG and SCG configuration information), and the CPAC execution conditions configured for each candidate PSCell. The container may also contain CPAC evaluation maintenance indication information and/or CPAC monitoring range indication information and/or monitoring timer T, and C-RNTI and/or CG configuration ID corresponding to the MCG configuration. The candidate target master base station sends it to the source base station in the form of container, and then the source base station sends it to the UE. The message also contains the following information:
(3.1) Cell radio network temporary identifier (C-RNTI), used as the ID of the UE in the candidate PCell. Different MCG configurations provided by the candidate PCell for the UE may be distinguished by allocating different C-RNTIs to the UE. The C-RNTIs allocated by the T-MN to the UE in the candidate PCell will be contained in the MCG configurations.
(3.2) Cell group configuration ID (CellGroupConfigId). It is used to identify different MCG configurations provided by the PCell for the UE. If Method 1 is used, different C-RNTIs need to be allocated to the UE to distinguish the MCG configurations. If Method 2 is used, that is, different MCG configurations are distinguished through the CG configuration ID, then the same C-RNTI may be allocated to the UE in the candidate PCell.
(4) Indication information of the number of PSCells to prepare, which may be “Number of PSCells to prepare”, used to indicate the number of candidate PSCells actually configured for the requested candidate target cell. After receiving the indication information, the source base station can determine the current number of conditional configurations for the UE, so as to determine whether to request conditional configurations of other candidate base stations for the UE in the subsequent configuration within the capability of the UE. In this way, within the capability of the UE, as many candidate cells as possible may be selected for the UE, which is beneficial for the UE to select an appropriate target cell to access.
(5) CPAC evaluation maintenance indication information, which is used to determine whether the UE needs to perform CPAC monitoring on the candidate PSCells after completing the PCell change, when there is a candidate PCell that meets the CHO execution conditions and the candidate PSCells do not meet the CPAC execution conditions, or when there is a candidate PCell that meets the CHO execution conditions and the candidate PSCells meet the CPAC execution conditions, but the PCell and the PSCells do not match. The indication information may be of enumeration type. If it is “true”, then the UE will continue to perform CPAC monitoring on the candidate PSCells after completing the CHO. The CPAC evaluation maintenance indication information may be contained in the container from the candidate target base station to the source base station.
(6) CPAC monitoring range indication information, which is used to indicate that, after the UE selects a PCell as the target cell and completes the CHO handover, if it is still necessary to continue to perform CPAC monitoring on the candidate PSCells, whether candidate PSCells that need to be continuously monitored are PSCells corresponding to the selected target PCell, or all candidate PSCells configured by the network for the UE. The CPAC monitoring range indication information may be contained in the container from the candidate target base station to the source base station.
(7) Monitoring timer T. When the CPAC evaluation maintenance indication information is “true”, the timer is used to instruct the UE to monitor the time of CPAC. When the timer expires, if no PSCell meets the CPAC execution conditions, the UE needs to notify the network.

Through the setting of the CPAC evaluation maintenance indication information, the CPAC monitoring range indication information and the monitoring timer, the behavior of the UE is indicated, and the implementation of the handover mechanism of CHO+CPAC is controlled and managed, so as to ensure that the UE can complete the handover mechanism of CHO+CPAC to access an appropriate target PCell and PSCell, thus to ensure the service transmission quality of the UE and ensure the service throughput.

In step 805, the source base station sends a reconfiguration message to a terminal UE, and sends CHO+CPAC configuration information to the UE. The message contains at least one of the following information:
(1) ID information of candidate Pcells, which may be conditional configuration ID condReconfigId or PCell ID or CGI or other ID information.
(2) Candidate PSCell list information, including ID information of each candidate PSCell, which may be conditional configuration ID condReconfigId or PSCell ID or CGI or other ID information. Wherein, if condReconfigId may be used, the candidate PSCell may use the same condReconfigId as the candidate Pcell, or use a different condReconfigId. If a different condReconfigId is used, the condReconfigId is distinguished by using condReconfigId for PCell and condReconfigId for PSCell, or distinguished in other ways.
(3) CHO execution conditions, indicating the conditions that the cell measurement results of candidate PCells need to meet when the UE executes CHO.
(4) CPAC execution conditions, indicating the conditions that the cell measurement results of candidate PSCells need to meet when the UE executes CPAC.
(5) CG configuration information, including MCG configuration information corresponding to each candidate PCell, and SCG configuration information corresponding to each candidate PSCcell. It may further include CPAC evaluation maintenance indication information and/or CPAC monitoring range indication information and/or monitoring timer T, and C-RNTI and/or CG configuration ID. The CG configuration information is sent by the candidate target base station to the source node in the form of container, and sent by the source base station to the UE.

Wherein:
(5.1) C-RNTI, UE ID in the requested target cell. Different C-RNTIs may be allocated for different MCG configurations in the requested target cell.
(5.2) CG configuration ID. It is used to identify different MCG configurations configured for the UE in the requested target cell. If Method 1 is used, different C-RNTIs need to be allocated to the UE to distinguish the MCG configurations. If Method 2 is used, that is, different MCG configurations are distinguished through the CG configuration ID, then the same C-RNTI may be allocated to the UE in the candidate PCells.
(5.3) CPAC evaluation maintenance indication information, which is used to determine whether the UE needs to perform CPAC monitoring on the candidate PSCells after completing the PCell change, when there is a candidate PCell that meets the CHO execution conditions and the candidate PSCells do not meet the CPAC execution conditions, or when there is a candidate PCell that meets the CHO execution conditions and the candidate PSCells meet the CPAC execution conditions, but the PCell and the PSCells do not match. If it is “true”, then the UE will continue to perform CPAC monitoring on the candidate PSCells after completing the CHO. The CPAC evaluation maintenance indication information may be contained in the container from the candidate target base station to the source base station.
(5.4) CPAC monitoring range indication information, which is used to indicate that, after the UE selects a PCell as the target cell and completes the CHO handover, if it is still necessary to continue to perform CPAC monitoring on the candidate PSCells, whether candidate PSCells that need to be continuously monitored are PSCells corresponding to the selected target PCell, or all candidate PSCells configured by the network for the UE. The CPAC monitoring range indication information may be contained in the container from the candidate target base station to the source base station.
(5.5) Monitoring timer T. When the CPAC evaluation maintenance indication information is “true”, the timer T is used to instruct the UE to monitor the time of CPAC. When the timer expires, if no PSCell meets the CPAC execution conditions, the UE needs to notify the network.
(6) Correspondence information between candidate PCells and candidate PSCells, indicating the candidate PSCells or a list of candidate PSCells corresponding to the PCell.

When the CHO and CPAC execution conditions of the candidate PCell and the corresponding candidate PSCells cannot be met at the same time, the UE determines its behavior according to the received CPAC evaluation maintenance indication information, CPAC monitoring range indication information and monitoring timer information. The access an appropriate target PCell and target PSCell is realized, so that the service transmission quality of the UE can be ensured and also the service throughput can be ensured.

The reconfiguration message may be an RRCReconfiguration message, or an RRC-ConnectionReconfiguration message, or other messages.

In step 806, the UE sends a reconfiguration complete message to the source base station, instructing the UE to complete configurations other than CHO+CPAC according to the configuration information sent by the source base station, and save the configuration information of CHO+CPAC.

The reconfiguration complete message may be an RRCReconfigurationComplete message, or an RRCConnectionReconfigurationComplete message, or other messages.

In step 807, the UE monitors the candidate PCells and PSCells. When there is a candidate PCell that meets the CHO execution conditions, the UE will select a target cell. If the UE selects PCell1 in the T-MN1 as the target cell, then step 808 is executed to complete the random access process.

In step 808, the UE performs a random access process in the selected target cell PCell1 to complete uplink synchronization. If a four-step random access process is adopted, the message 3 (Msg3) sent by the UE may contain the C-RNTI and/or CG configuration ID; and, if a two-step random access process is adopted, the MSGA sent by the UE may contain the C-RNTI and/or CG configuration ID.

In step 809, the UE sends a reconfiguration complete message to the target master base station T-MN1. It is used to instruct the UE to select the cell PCell of the master base station as the target cell. If the candidate PSCells corresponding to the target cell PCell meet the CPAC execution conditions at the same time, the message will further contain the candidate PSCell selected by the UE and the reconfiguration complete message sent to the SN; if a candidate PSCell meets the CPAC execution conditions, but the PSCell does not correspond to the PCell, the message will contain the list information and/or measurement result information of PSCells that meet the CPAC execution conditions; if there is no candidate PSCell that meets the CPAC execution conditions, the message may contain the measurement result information. If, in step 804, Method 1 is used to distinguish different MCG configurations in the PCell, then the UE contains, in the MAC PDU containing the reconfiguration complete message sent to the T-MN1, the MAC CE of the C-RNTI which corresponds to the MCG configuration selected by the UE. If Method 2 is used to distinguish different MCG configurations in the PCell, the message will carry the CG configuration ID of the MCG selected by the UE. The message contains at least one of the following information:
(1) ID information of the selected PSCell, which is used to indicate the ID of the candidate PScell selected by the UE that meets the CPAC execution conditions. CondReconfigId may be used to identify the candidate PSCell ID.
(2) SN reconfiguration complete message, which is the SN reconfiguration complete message sent to the T-SN. When the UE selects a target PSCell and completes the corresponding SCG configuration, it will send the SN reconfiguration complete message in the form of container and contain it in the reconfiguration complete message sent to the target master base station.
(3) PSCell list information, indicating the IDs of the candidate PSCells that meet the CPAC execution conditions, which may be CGIs (Cell Global Identifiers).
(4) Measurement result information, which provides the UE's measurement results for cells, and is used for the network to select an appropriate PSCell.

When there is a candidate PCell that meets the CHO execution conditions, if the candidate PSCells meet the CPAC execution conditions, but the PSCells do not correspond to the PCell, or if there is no candidate PSCell that meets the CPAC execution conditions, the UE will send the list information and/or measurement results of the PSCells to the T-MN. According to the list information and/or measurement results of the PSCells, the T-MN can reselect an appropriate target PSCell for the UE to access in time, thereby reducing the service interruption delay of the UE and ensuring the service transmission quality of the UE.

The reconfiguration complete message may be an RRCReconfigurationComplete message, or an RRCConnectionReconfigurationComplete message, or other messages.
(5) CG configuration ID, used to indicate the ID of the MCG configuration. According to the ID, the T-MN can determine the MCG configuration selected by the UE.

If the reconfiguration complete message in step 809 contains “SN reconfiguration complete message” and “selected PSCell ID information”, it means that there is a candidate PSCell that meets the CPAC execution conditions, and there is a corresponding relationship between the PSCell and the PCell. The T-MN1 will determine the T-SN where the PSCell is located according to the “selected PSCell ID information”, and step 810 is executed.

In step 810, the candidate target master node T-MN1 sends a secondary node reconfiguration complete message to the candidate target secondary node T-SN1.

In step 811, the UE and the target secondary node T-SN1 complete the random access process to realize uplink synchronization, and the UE accesses the target PSCell.

In step 812, the target master base station T-MN1 sends a HANDOVER SUCCESS message to the source base station, indicating that the CHO+CPAC execution process is completed. The message contains at least one of the following information:
(1) UE ID information, containing the ID of the UE on the source base station (Source NG-RAN node UE XnAP ID) and the ID of the UE on the target master base station (Target NG-RAN node UE XnAP ID).
(2) Target PSCell ID, indicating the target PSCell ID selected by the UE, which may be NR CGI or E-UTRA CGI. The source base station contains the PSCell ID in the handover cancel message sent to other candidate T-MNs. If the target PSCell belongs to the candidate T-SN corresponding to the candidate T-MN, then the T-MN will instruct the T-SN to keep the communication context information of the UE when releasing the secondary node, so as to avoid deleting the context of the UE and affecting the connection between the UE and the T-SN and the service transmission of the UE.

In step 813, the source base station sends a HANDOVER CANCEL message to the candidate target master base station T-MN2, which is used to instruct the T-MN2 to release the handover resources configured for the UE. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Target PSCell ID, indicating the target PSCell ID for the UE, which may be NR CGI or E-UTRA CGI. The ID is obtained by the source base station from the target master base station in step 817. According to the target PSCell ID, the T-MN2 can determine whether the target cell selected by the UE belongs to the T-SN2. If the target cell selected by the UE belongs to the T-SN2, then the T-MN2 will instruct the T-SN2 to keep the context information of the UE when sending the secondary node release request, so as to avoid deleting the context of the UE and affecting the connection between the UE and the T-SN2 and the service transmission of the UE.

In step 814, the candidate target master base station T-MN2 sends a secondary node release request message to the candidate target secondary base station T-SN2, to instruct the T-SN2 to release the SCG resources allocated to the UE and instruct the T-SN2 to determine whether to release the communication context of the UE. The T-MN2 determines whether the cell is a cell in the candidate target secondary base station T-SN2 selected by the T-MN2 for the UE, according to the target PSCell ID of the UE received in step 813. If so, when sending the secondary node release request to the T-SN2, it will instruct the T-SN2 to keep the communication context information of the UE. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) UE communication context kept indicator, indicating that the communication context of the UE is kept in the T-SN2.

The secondary node release request message may be an S-NODE RELEASE REQUEST message, or an SENB RELEASE REQUEST message, or other messages.

In step 815, the candidate target secondary base station T-SN2 sends a secondary node release request acknowledge message to the candidate target master base station T-MN2.

Therefore, the network controls and manages the execution of CHO+CPAC, instructs the behavior of the UE, and reports secondary information and enhanced information between nodes through the UE, so as to ensure that the UE can complete the execution of CHO+CPAC as soon as possible and access the appropriate target PCell and PSCell. This reduces the handover delay, ensures the service transmission quality of the UE, ensures the service throughput, and also reduces the node processing overhead.

### Embodiment 8: An Execution Method Under the Mechanism of CHO+CPAC is Provided

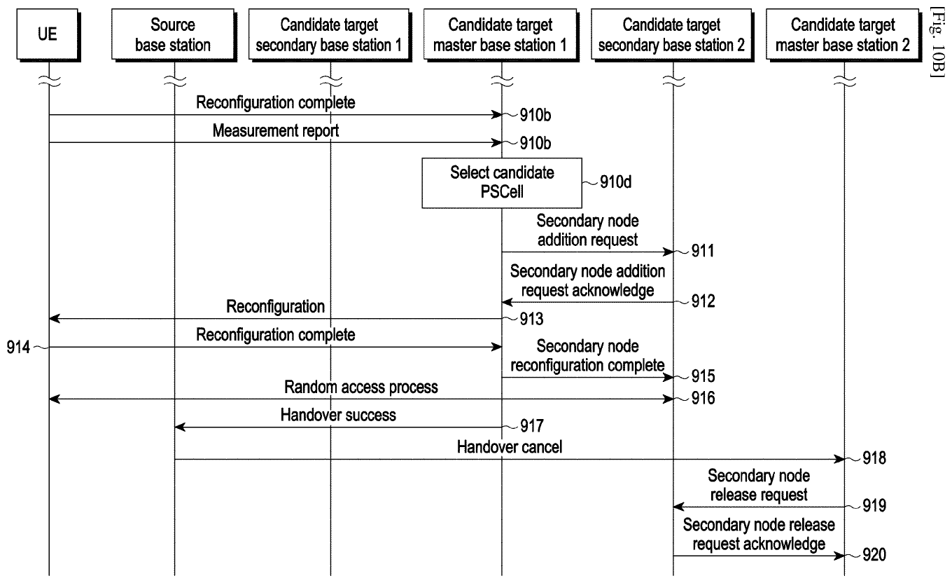

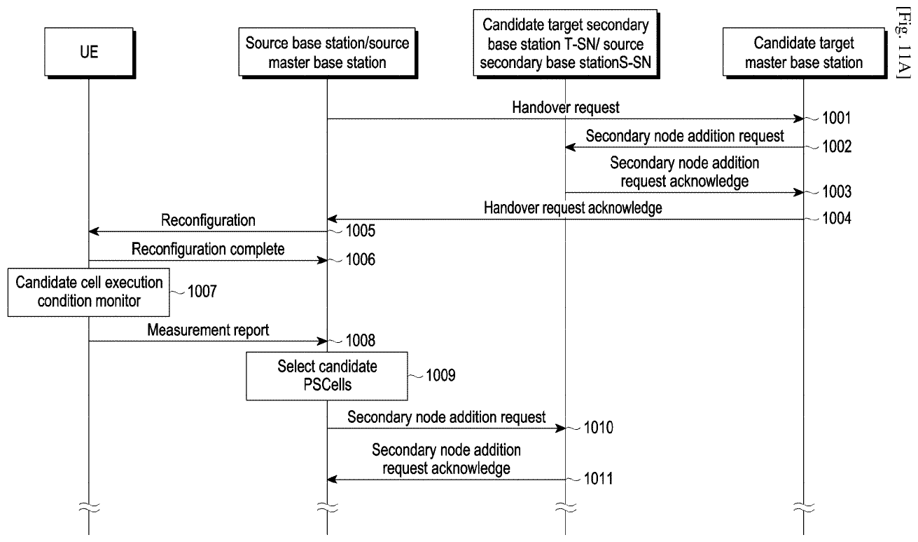

This process shows how the UE completes the execution of the mechanism of CHO+CPAC and accesses the target PCell and target PSCell when there is a PCell that meets the CHO execution conditions, but no PScell meets the execution conditions, or when there is a candidate PCell that meets the CHO execution conditions and there are candidate PSCells that meet the CPAC execution conditions, but there is no corresponding relationship between the candidate PCell and the candidate PSCells. FIGS. 10A and 10B shows the schematic diagram of the process. In this flow, the source side may be in single connectivity or dual connectivity state, which does not affect the description of the whole flow. Therefore, only the source base station is used in FIGS. 10A and 10B and the method description, which collectively represents the source base station for the single connectivity state and the source master base station for the dual connectivity state.

Steps 901-906 are the same as steps 801-806 and will not be repeated here.

In step 907, the UE monitors the candidate PCells and PSCells. When there is a candidate PCell that meets the CHO execution conditions and there are candidate PSCells that meet the CPAC execution conditions, but there is no corresponding relationship between any candidate PSCell that meets the CPAC execution conditions and the candidate PCell that meets the CHO execution conditions, or when there is a PCell that meets the CHO execution conditions, but no PScell meets the execution conditions, the UE will execute the CHO process. If the UE selects PCell1 in the T-MN1 as the target cell, then step 908 will be executed.

In step 908, the UE performs a random access process in the selected target cell PCell1 to complete uplink synchronization.

In step 909, the UE sends a reconfiguration complete message to the target master base station T-MN1. It is used to instruct the UE to select the cell PCell of the master base station as the target cell. If there is a candidate PSCell that meets the CPAC execution conditions, and there is a corresponding relationship between the PSCell and the PCell, then the message contains the selected PSCell ID information. If there is a candidate PSCell that meets the CPAC execution conditions, but there is no corresponding relationship between the PSCell and the PCell, then the message may contain list information and/or measurement result information of PSCells that meet the CPAC execution conditions. If no candidate PSCell meets the CPAC execution conditions, then the message may contain measurement result information. The message contains at least one of the following information:
(1) ID information of the selected PSCell, which is used to indicate the ID of the candidate PScell selected by the UE that meets the CPAC execution conditions. CondReconfigId may be used to identify the candidate PSCell ID.
(2) PSCell list information, indicating the IDs of the candidate PSCells that meet the CPAC execution conditions, which may be CGIs (Cell Global Identifiers).
(3) Measurement result information, which provides the UE's measurement results for cells, and is used for the network to select an appropriate PSCell. When there is a candidate PCell that meets the CHO execution conditions, if the candidate PSCells meet the CPAC execution conditions, but the PSCells do not correspond to the PCell, or if there is no candidate PSCell that meets the CPAC execution conditions, the UE will send the list information and/or measurement results of the PSCells to the T-MN. According to the list information and/or measurement results of the PSCells, the T-MN can reselect an appropriate target PSCell for the UE to access in time, thereby reducing the service interruption delay of the UE and ensuring the service transmission quality of the UE. The reconfiguration complete message may be an RRCReconfigurationComplete message, or an RRCConnectionReconfigurationComplete message, or other messages.

When there is a candidate PSCell that meets the CPAC execution conditions, but there is no corresponding relationship between the PSCell and the PCell, or when there is no candidate PSCell that meets the CPAC execution conditions, if, in the reconfiguration message in step 905, “CPAC evaluation maintenance indication information” indicates the UE to continue to perform CPAC monitoring on the PSCell after the CHO handover, then the UE will perform step 910a.

In step 910a, the UE will start the timer T according to the CPAC monitoring range indication information and monitoring timer T information received in the reconfiguration message in step 905, and measure the candidate PSCells according to the monitoring range provided by the “CPAC monitoring range indication information”.

The T-MN1 can determine, according to the information contained in the reconfiguration complete message sent by the UE in step 909, whether there is an appropriate PSCell. If the T-MN1 determines that there is an appropriate PSCell, step 910d will be directly executed. If there is no appropriate PSCell, or there is no measurement result in step 909, the T-MN1 waits for the CPAC monitoring results from the UE. That is, step 910b and/or step 910c is executed.

If the UE detects that there is a PSCell that meets the CPAC execution conditions before the timer T expires, and that the PSCell corresponds to the target PCell, then step 910b is executed. If, when the timer T expires, the UE detects that there is no PSCell that meets the CPAC execution conditions, or the UE detects that there is a PSCell that meets the CPAC execution conditions but the PSCell does not correspond to the target PCell, then step 910c is executed.

In step 910b, the UE sends a reconfiguration complete message to the target master base station T-MN1, indicating that there is a PSCell that meets the CPAC execution conditions. The message contains at least one of the following information:
(1) ID information of the selected PSCell, which is used to indicate the ID of the candidate PScell selected by the UE that meets the CPAC execution conditions. CondReconfigId may be used to identify the candidate PSCell ID.
(2) SN reconfiguration complete message, which is the SN reconfiguration complete message sent to the T-SN. When the UE selects a target PSCell and completes the corresponding SCG configuration, it will send the SN reconfiguration complete message in the form of container and contain it in the reconfiguration complete message sent to the target master base station.
(3) PSCell list information, indicating the IDs of the candidate PSCells that meet the CPAC execution conditions, which may be CGIs (Cell Global Identifiers) or other cell IDs.
(4) Measurement result information, which provides the UE's measurement results for cells, and is used for the network to select an appropriate PSCell.

If, in step 910b, the reconfiguration complete message contains “selected PSCell ID information” and “SN reconfiguration complete message”, it means that the UE has completed the selection of the target PCell and target PSCell, so the subsequent process is the same as that in Embodiment 7, that is, steps 810-815, which will not be repeated here.

The reconfiguration complete message may be an RRCReconfigurationComplete message, or an RRCConnectionReconfigurationComplete message, or other messages.

In step 910c, the UE sends a MeasurementReport message or other messages to the target master base station T-MN1, containing the UE's measurement results for cells. It is used for the T-MN1 to select an appropriate PSCell for the UE. The message contains at least one of the following information:
(1) PSCell list information, indicating the IDs of the candidate PSCells that meet the CPAC execution conditions, which may be CGIs (Cell Global Identifiers) or other cell IDs.
(2) Measurement result information, which provides the UE's measurement results for cells, and is used for the network to select an appropriate PSCell.

In step 910d, the T-MN1 selects an appropriate target PSCell for the UE according to the measurement results provided by the UE in step 909 or step 910c, or the PSCell list information. When the T-MN1 determines a target PSCell2 for the UE and this cell belongs to the T-SN2, the T-MN1 will send a message to the T-SN2, perform a secondary node addition process, and configure SCGs for the UE.

In step 911, the candidate target master base station T-MN1 sends a secondary node addition request message to the candidate target secondary base station T-SN2, to request the T-SN2 to allocate SCG resources for the UE. The message contains the ID information of the PSCell2 selected by the T-MN1 for the UE, indicates that the PSCell2 is used as the target PSCell of the UE, and requests the T-SN2 to configure SCG resources for the UE. The message further includes the node ID of the source node and the ID information allocated by the source node to the UE.

The message contains at least one of the following information:
(1) UE ID information, indicating the ID of the UE at the candidate target master base station, that is, master NG-RAN node UE XnAP ID (M-NG-RAN node UE XnAP ID).
(2) Identity of the source node and the UE ID information on the source node. The ID of the source node, that is, source M-NG-RAN node ID, may be Global NG-RAN Node ID. The ID of the UE on the source node, that is, source M-NG-RAN node UE XnAP ID, may be NG-RAN node UE XnAP ID. The ID information is the same as the source node ID sent by the T-MN2 to the T-SN in step 902b and the UE ID information at the source node. After the T-SN2 receives the ID information, it can determine whether the UE has established a communication context on the T-SN2 and whether SCG resources have been configured. If the communication context has been established and SCG resources have been configured, the T-SN2 can avoid repeated communication context establishment and SCG resource configuration for the UE.
(3) PSCell ID, indicating that PSCell2 is requested to be the target PSCell for the UE. The ID may be NR CGI or E-UTRA CGI.
(4) Container from the master base station to the secondary base station, that is, M-NG-RAN node to S-NG-RAN node container, containing the cell group configuration information CG-ConfigInfo for the SCG.

The secondary node addition request message may be an S-NODE ADDITION REQUEST message, or an SGNB ADDITION REQUEST message, or other messages.

In step 912, the candidate target secondary base station T-SN2 sends a secondary node addition request acknowledge message to the candidate target master base station T-MN1, instructing the T-SN2 to accept the request from the T-MN1 to use PSCell2 as the target PSCell for the UE, and to configure SCG resource information for the UE. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) Container from the secondary node to the master node, containing a cell group candidate list message (CG-CandidateList) or a cell group configuration message (CG-Config), containing information such as the CG configuration corresponding to the candidate PSCell2 for the UE.
(3) Requested PSCell ID, indicating the acceptance of using PSCell2 as the target PSCell of the UE. The ID may be NR CGI or E-UTRA CGI.

The secondary node addition request acknowledge message may be an S-NODE ADDITION REQUEST ACKNOWLEDGE message, or an SGNB ADDITION REQUEST ACKNOWLEDGE message, or other messages.

In step 913, the target master node sends a reconfiguration message to the UE, and sends SCG configuration information to the UE. The message contains at least one of the following information:
(1) SCG configuration message, contained in the information element mrdc-SecondaryCellGroup. The message is generated by the candidate secondary node, sent to the master node in the form of container, and then sent to the UE by the master node. It contains the SCG radio resource configuration information of the candidate master and secondary cells selected by the secondary node for the UE.

The reconfiguration message may be an RRCReconfiguration message, or an RRC-ConnectionReconfiguration message, or other messages.

In step 914, the UE sends a reconfiguration complete message to the target master node T-MN1. The message indicates that the UE has completed SCG reconfiguration and is about to access the target PSCell. This message contains the SN reconfiguration complete message sent to the T-SN2.

The reconfiguration complete message may be an RRCReconfigurationComplete message, or an RRCConnectionReconfigurationComplete message, or other messages.

In step 915, the target master node T-MN1 sends a secondary node reconfiguration complete message to the target secondary node T-SN2. The message indicates that the UE has completed SCG configuration and is about to access the target PSCell.

In step 916, the UE completes the random access process to the target secondary node T-SN2 to realize uplink synchronization.

In step 917, the target master base station T-MN1 sends a HANDOVER SUCCESS message to the source base station, indicating that the CHO+CPAC execution process is completed. The message contains at least one of the following information:
(1) UE ID information, containing the ID of the UE on the source base station (Source NG-RAN node UE XnAP ID) and the ID of the UE on the target master base station (Target NG-RAN node UE XnAP ID).
(2) Target PSCell ID, indicating the target PSCell ID selected by the UE, which may be NR CGI or E-UTRA CGI. The source base station contains the target PSCell ID in the handover cancel message sent to other candidate T-MNs. If the target PSCell belongs to the candidate T-SN corresponding to the candidate T-MN, then the T-MN will instruct the T-SN to keep the communication context information of the UE when releasing the secondary node, so as to avoid deleting the context of the UE and affecting the connection between the UE and the T-SN and the service transmission of the UE.

In step 918, the source base station sends a HANDOVER CANCEL message to the candidate target master base station T-MN2, which is used to instruct the T-MN2 to release the handover resources configured for the UE. The message contains at least one of the following information:
(1) UE ID information, containing the ID of the UE on the source base station (Source NG-RAN node UE XnAP ID) and the ID of the UE on the candidate target master base station (Target NG-RAN node UE XnAP ID).
(2) Target PSCell ID, indicating the target PSCell ID for the UE, which may be NR CGI or E-UTRA CGI. The ID is obtained by the source base station from the target master base station in step 917. According to the target PSCell ID, the T-MN2 can determine whether the target cell selected by the UE belongs to the T-SN2. If the target cell selected by the UE belongs to the T-SN2, then the T-MN2 will instruct the T-SN2 to keep the context information of the UE when sending the secondary node release request, so as to avoid deleting the context of the UE and affecting the connection between the UE and the T-SN2 and the service transmission of the UE.

In step 919, the candidate target master base station T-MN2 sends a secondary node release request message to the candidate target secondary base station T-SN2, to instruct the T-SN2 to release the SCG resources allocated to the UE and instruct the T-SN2 to determine whether to release the communication context of the UE. The T-MN2 determines whether the cell is a cell in the candidate target secondary base station T-SN2 selected by the T-MN2 for the UE, according to the target PSCell ID of the UE received in step 918. If so, when sending the secondary node release request to the T-SN2, it will instruct the T-SN2 to keep the communication context information of the UE. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) UE communication context kept indicator, indicating that the communication context of the UE is kept in the T-SN2.

The secondary node release request message may be an S-NODE RELEASE REQUEST message, or an SENB RELEASE REQUEST message, or other messages.

In step 920, the candidate target secondary base station T-SN2 sends a secondary node release request acknowledge message to the candidate target master base station T-MN2.

Therefore, the network controls and manages the execution of CHO+CPAC, instructs the behavior of the UE, and reports secondary information and enhanced information between nodes through the UE, so as to ensure that the UE can complete the execution of CHO+CPAC as soon as possible and access the appropriate target PCell and PSCell. This reduces the handover delay, ensures the service transmission quality of the UE, ensures the service throughput, and also reduces the node processing overhead.

### Embodiment 9: An Execution Process Under the Mechanism of CHO+CPAC is Provided

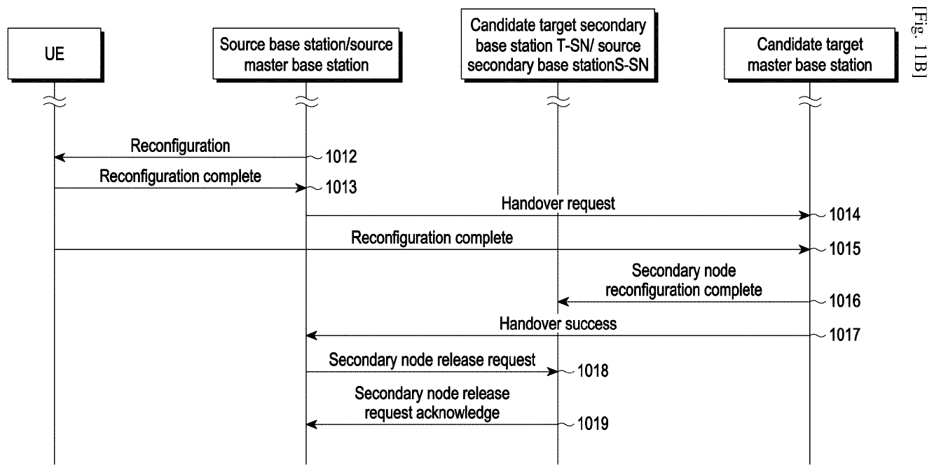

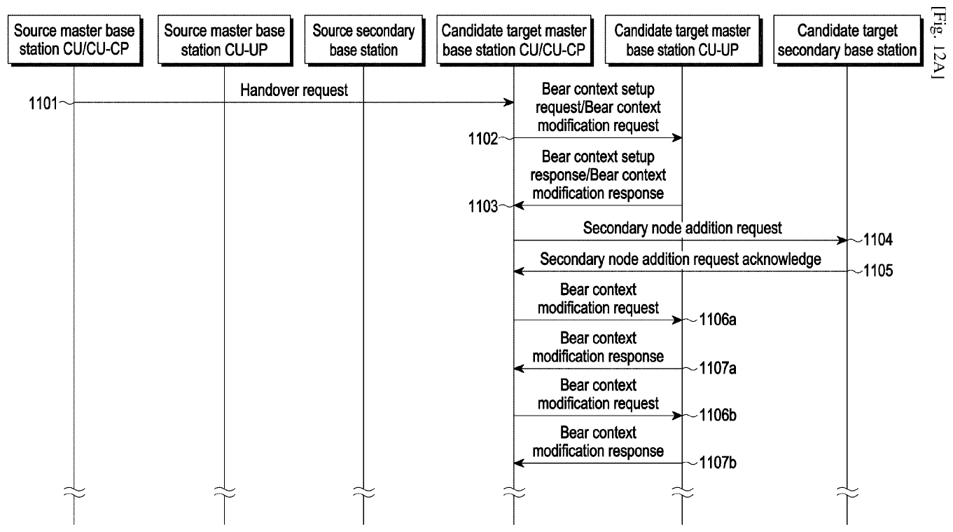

This process shows how the UE completes the execution of the mechanism of CHO+CPAC and accesses the target PCell and target PSCell when there is a PScell that meets the execution conditions but there is no PCell that meets the CHO execution conditions. In this scenario, in order to enable the UE to select an appropriate cell to perform handover as soon as possible without affecting the service transmission of the UE, the source base station uses the PSCell that meets the CPAC execution conditions as the PSCell of the UE, establishes DC for the UE or changes the source SN of the UE. Therefore, when the candidate PCell meets the CHO execution conditions, a handover process in which the master base station is changed but the secondary base station is not changed may be performed. In this way, by completing the selection of the PSCell first and then the selection of the PCell, it is ensured that the UE can complete the execution of CHO+CPAC, and the UE can timely select the ideal target PCell and PSCell and make adjustment. This ensures the service transmission quality of the UE and also ensures the service throughput. FIGS. 11A and 11B show the schematic diagram of the process. In this flow, the source side may be in single connectivity or dual connectivity state, which does not affect the description of the whole flow. Therefore, only the source base station is used in FIGS. 11A and 11B and the method description, which collectively represents the source base station for the single connectivity state and the source master base station for the dual connectivity state.

Steps 1001-1006 are the same as steps 801-806 and will not be repeated here.

In step 1007, the UE monitors the candidate PCells and PSCells, and when it finds that there are candidate PSCells that meet the CPAC execution conditions but there is no candidate PCell that meets the CHO execution conditions, then the UE will execute step 1008.

In step 1008, the UE sends a MeasurementReport message or other messages to the source base station, containing the UE's measurement results for cells, which is used for the source base station to determine whether to select an appropriate PSCell for the UE. The message contains at least one of the following information:
(1) PSCell list information, indicating the IDs of the candidate PSCells that meet the CPAC execution conditions, which may be CGIs (Cell Global Identifiers).
(2) Measurement result information, which provides the UE's measurement results for cells, and is used for the network to select an appropriate PSCell.

When there are candidate PSCells that meet the CPAC execution conditions but there is no candidate PCell that meets the CHO execution conditions, the S-MN can first determine a target PSCell that meets the CPAC execution conditions for the UE through the list information and/or measurement results of the PSCells. When there is a candidate PCell that meets the CHO execution conditions, a process in which the MN is changed without the SN change may be performed. When waiting for the candidate PCell to meet the CHO execution conditions, an appropriate PSCell is first selected for the UE, which improves the service throughput of the UE.

In step 1009, the source base station selects an appropriate PSCell for the UE according to the measurement results provided by the UE in the step 1008, or the PSCell list information. When the source base station determines the PSCell for the UE, and the cell belongs to the candidate target secondary base station T-SN, the source base station sends a message to the T-SN, and performs step 1010.

In step 1010, the source base station sends a secondary node addition request message to the secondary base station T-SN, containing the PSCell ID information selected by the source base station for the UE, to request the T-SN to configure SCG resources for the UE. The message contains at least one of the following information:
(1) UE ID information, indicating the ID of the UE at the candidate target master base station, that is, master NG-RAN node UE XnAP ID (M-NG-RAN node UE XnAP ID).
(2) PSCell ID, indicating the ID requested to be used as the PSCell for the UE. The ID may be NR CGI or E-UTRA CGI.
(3) Container from the master base station to the secondary base station, that is, M-NG-RAN node to S-NG-RAN node container, containing the cell group configuration information CG-ConfigInfo for the SCG.

The secondary node addition request message may be an S-NODE ADDITION REQUEST message, or an SGNB ADDITION REQUEST message, or other messages.

In step 1011, the secondary base station T-SN sends a secondary node addition request acknowledge message to the source base station, to instruct the T-SN to accept the request from the source base station to use the PSCell as the target PSCell for the UE, and configure SCG resource information for the UE. The message contains at least one of the following information:
(1) UE ID information, containing the ID of the UE on the candidate target master base station (M-NG-RAN node UE XnAP ID) and the ID of the UE on the candidate target secondary base station (S-NG-RAN node UE XnAP ID).
(2) Container from the secondary node to the master node, containing a cell group candidate list message (CG-CandidateList) or a cell group configuration message (CG-Config), containing information such as the SCG configuration corresponding to the PSCell2 for the UE.
(3) Requested PSCell ID, indicating the ID accepted to be used as the PSCell for the UE. The ID may be NR CGI or E-UTRA CGI.

The secondary node addition request acknowledge message may be an S-NODE ADDITION REQUEST ACKNOWLEDGE message, or an SGNB ADDITION REQUEST ACKNOWLEDGE message, or other messages.

In step 1012, the source base station sends a reconfiguration message to the UE, and sends SCG configuration information to the UE. The message contains at least one of the following information:
(1) SCG configuration message, contained in the information element mrdc-SecondaryCellGroup. The message is generated by the candidate secondary node, sent to the master node in the form of container, and then sent to the UE by the master node. It contains the SCG radio resource configuration information of the candidate master and secondary cells selected by the secondary node for the UE.

The reconfiguration message may be an RRCReconfiguration message, or an RRC-ConnectionReconfiguration message, or other messages.

In step 1013, the UE sends a reconfiguration complete message to the source base station. The message indicates that the UE has completed SCG reconfiguration and is about to access the PSCell. This message contains the SN reconfiguration complete message sent to the T-SN.

The reconfiguration complete message may be an RRCReconfigurationComplete message, or an RRCConnectionReconfigurationComplete message, or other messages.

In step 1014, the source base station sends a handover request message to the candidate target master base station, indicating that the UE is currently in the DC state or that the UE has updated the source SN, as well as the ID of the source secondary base station and the UE ID information at the source secondary base station. The message contains at least one of the following information:
(1) The ID of the source secondary base station, that is, Source S-NG-RAN node ID, may be Global NG-RAN Node ID.
(2) ID information of the UE at the source secondary base station, that is, the Source S-NG-RAN node UE XnAP ID, which may be NG-RAN node UE XnAP ID.

When the UE detects a candidate PCell that meets the CHO execution conditions and there is a corresponding relationship between the candidate PCell and the source PSCell, the UE performs step 1015 by using the MCG and SCG configurations of the candidate PCell and the source PSCell received during the handover configuration stage. Then, S-SN becomes T-SN.

In step 1015, the UE sends a reconfiguration complete message to the target master base station, which is used to instruct the UE to select a PCell in the master base station as the target cell, and indicate information about the selected PSCell. The message contains at least one of the following information:
(1) ID information of the selected PSCell, which is used to indicate the ID of the candidate PScell selected by the UE that meets the CPAC execution conditions. CondReconfigId may be used to identify the candidate PSCell ID.
(2) Source PSCell indication information, indicating that the selected PSCell is the source PSCell.
(3) SN reconfiguration complete message, which is the SN reconfiguration complete message sent to the T-SN. When the UE selects a target PSCell and completes the corresponding SCG configuration, it will send the SN reconfiguration complete message in the form of container and contain it in the reconfiguration complete message sent to the target master base station.

The reconfiguration complete message may be an RRCReconfigurationComplete message, or an RRCConnectionReconfigurationComplete message, or other messages.

In step 1016, the target master base station sends a secondary node reconfiguration complete message to the target secondary node T-SN, indicating that the UE has completed SCG configuration. The message contains at least one of the following information:
(1) PCell ID, which indicates the PCell corresponding to the PSCell accessed by the UE. According to the ID, the T-SN can determine the corresponding SCG configuration. The PCell ID may be global NG-RAN cell ID.

The secondary node reconfiguration complete message may be an S-NODE RECONFIGURATION COMPLETE message, or an SENB RECONFIGURATION COMPLETE message, or other messages.

In step 1017, the target master base station T-MN1 sends a HANDOVER SUCCESS message to the source base station, indicating that the CHO+CPAC execution process is completed. The message contains at least one of the following information:
(1) UE ID information, containing the ID of the UE on the source base station (Source NG-RAN node UE XnAP ID) and the ID of the UE on the target master base station (Target NG-RAN node UE XnAP ID).
(2) Target PCell ID, indicating the target PCell ID selected by the UE, which may be NR CGI or E-UTRA CGI.
(3) Target PSCell ID, indicating the target PSCell ID selected by the UE, which may be NR CGI or E-UTRA CGI. The source base station can determine whether the target PSCell for the UE is the source PSCell according to the ID. If so, the source base station will instruct the source secondary base station to keep the communication context of the UE, so as to avoid deleting the context of the UE and affecting the connection between the UE and the T-SN2 and the service transmission of the UE.
(4) UE communication context kept indicator, indicating that the UE has selected the source PSCell as the target PSCell, and the source base station needs to let the source secondary base station keep the communication context of the UE.

In step 1018, the source base station sends a secondary node release request message to the source secondary base station, to indicate to the source secondary base station that the UE has adjusted the PCell, and to instruct the source secondary base station to keep the communication context of the UE. The message contains at least one of the following information:
(1) UE communication context kept indicator, indicating that the UE has selected the source PSCell as the target PSCell, and the source secondary base station needs to keep the communication context of the UE.

The secondary node release request message may be an S-NODE RELEASE REQUEST message, or an SENB RELEASE REQUEST message, or other messages.

In step 1019, the source secondary base station sends a secondary node release request acknowledge message to the source master base station.

Therefore, the network controls and manages the execution of CHO+CPAC, instructs the behavior of the UE, and reports secondary information and enhanced information between nodes through the UE, so as to ensure that the UE can complete the execution of CHO+CPAC as soon as possible and access the appropriate target PCell and PSCell. This reduces the handover delay, ensures the service transmission quality of the UE, ensures the service throughput, and also reduces the node processing overhead.

### Part IV: Forwarded Data Transmission Method

Under the mechanism of CHO+CPAC, if an early data forwarding mechanism is indicated, then the source master base station and/or source secondary base station will be required to forward data to each candidate T-MN and candidate T-SN in advance. If the T-SN does not become the target node for the UE, then the T-SN needs to discard the data. Under the mechanism of CHO+CPAC, there are multiple candidate T-SNs, so data needs to be forwarded to multiple T-SNs, resulting in waste of interface transmission resources between network nodes. Therefore, the present disclosure proposes a forwarded data transmission method, to optimize the data forwarding method and reduce the transmission overhead caused by data forwarding between multiple nodes.

When the source master base station or the source secondary base station needs to forward data to the candidate T-SNs, the data is first sent to the candidate T-MNs for buffer without data processing. When the UE selects a candidate T-MN as the target T-MN, and a candidate T-SN is also selected as the target T-SN for the UE, the T-MN forwards the buffered data forwarded from the source master base station and/or source secondary base station or source base station to the target T-SN. Or, when the UE selects a target T-MN and accesses the target PCell, the target T-MN forwards the buffered data forwarded from the source side (source base station or source master base station or source secondary base station) to each candidate T-SN. The data forwarded to each candidate T-SN is the data of the SN-terminated bearer. The SN-terminated bearer may also be called a service bearer established on the T-SN, or a service bearer of the T-SN. Therefore, under the mechanism of CHO+CPAC, unnecessary data transmission between nodes is avoided, the transmission overhead caused by data forwarding between multiple nodes is reduced, and the waste of interface transmission resources between nodes is reduced. This method can further avoid the increase of processing load on the data forwarding node T-MN. Under the mechanism of CHO+CPAC, different candidate T-MNs may select the same candidate T-SN for the UE. Therefore, when early data forwarding is supported, if the forwarded data from the source side is forwarded to a candidate T-SN through a candidate T-MN, different candidate T-MNs will forward the same data to the same candidate T-SN. Therefore, by this method, it is avoided to repeatedly forward the same data to the same candidate T-SN during early data forwarding under the mechanism of CHO+CPAC.

The forwarded data transmission method in the present disclosure is applicable to the CHO+CPAC scenario, and also applicable to other scenarios where data forwarding is required for dual connectivity handover.

### Embodiment 10: Forwarded Data Transmission Method

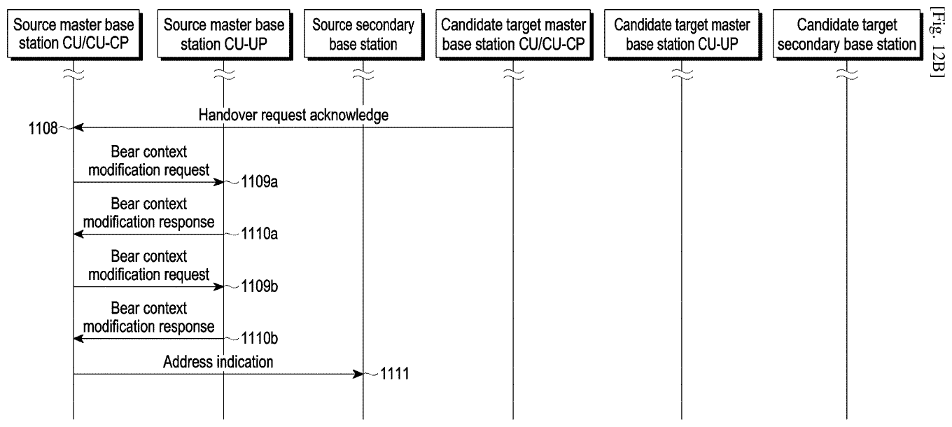

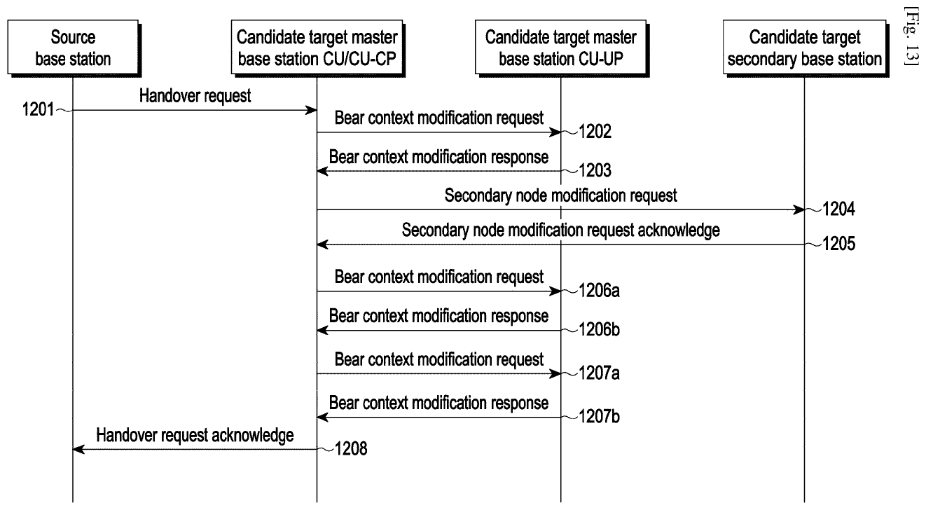

FIGS. 12A and 12B show the basic flow of the forwarded data transmission method in the handover preparation stage. The data forwarded from the source base station or the source secondary base station to the candidate T-SN is first sent to the candidate master base station T-MN, and then the candidate master base station T-MN sends it to the candidate target secondary node T-SN. Through such a mechanism, the candidate T-MN can buffer the data forwarded to the candidate T-SN, and then forward the data to the T-SN when the UE selects the candidate T-SN as the target T-SN. Or, when the UE selects a target T-MN and accesses the target PCell, the target T-MN forwards the buffered forwarded data from the source side to each candidate T-SN. Thus, the forwarding of data by the source master base station or the source secondary base station to multiple candidate target secondary base stations is avoided. This reduces the network transmission overhead caused by data forwarding between multiple nodes and avoids increasing the processing load on the T-MN.

In step 1101, the source master base station S-MN sends a handover request message or other messages to the candidate target master base station T-MN. This message is used to instruct the candidate target master base station to configure service bearer resources for the CHO handover of the UE or instruct the T-MN to perform configuration update due to the change of service bearers, and ask the candidate target master base station to provide address information to support early data forwarding.

In steps 1102-1103, the candidate target master base station CU/CU-CP and the candidate target master base station CU-UP complete the establishment of the UE bearer context, and complete the MCG configuration for the service bearers of the UE and the SCG service plane configuration. The establishment of the MN-terminated bearer is completed, wherein the MN-terminated bearer may also be called a service bearer established on the T-MN, or a service bearer of the T-MN.

The bearer context establishment request message may be a BEARER CONTEXT SETUP REQUEST message, or other messages. The bearer context establishment response message may be a BEARER CONTEXT SETUP RESPONSE message, or other messages.

In steps 1104-1105, the candidate target master base station and the candidate target secondary base station complete the SN addition process, and the candidate target secondary base station T-SN completes candidate PCell selection and SCG configuration for the UE. If the service bearers established by the UE on the T-SN need to perform early data forwarding, the T-SN will further provide address information A1 for early data forwarding. Data forwarding may be based on a DRB or a PDU session, the address information A1 may be data forwarding address information provided based on the DRB, or may be data forwarding address information provided based on the PDU session. The address information A1 may be data forwarding address information of one or more DRBs or data forwarding address information of one or more PDU sessions. The address information is user plane transport layer address information for uplink and downlink data forwarding, including an IP address and a tunnel identifier, specifically:
IP address, that is, transport layer address, that is, IP address used for user plane transport;
GTP tunnel identifier, that is, GTP tunnel endpoint identifier (GTP-TEID). To avoid unnecessary data transmission between nodes or the absence of direct data forwarding path for data forwarding between the T-SN and the source side under the mechanism of CHO+CPAC, the service bearers established on the T-SN need to adopt indirect early data forwarding. If the service bearers established on the T-SN need to support indirect early data forwarding, that is, the T-MN first receives the forwarded data from the source side and then forwards it to the target T-SN, then the T-MN will need to establish service bearers of the UE on the T-SN, assign address information A2 for early data forwarding of these service bearers, and provide the address information A2 to the source master base station/source secondary base station. Meanwhile, the T-MN also needs to associate the addresses A1 and A2 according to the service bearers, so that the forwarded data received from the source side can be correctly forwarded to the T-SN. This purpose is achieved through steps 1106a-1107b. In steps 1106a-1107a, the service bearers of the T-SN are established on the T-MN, and the address information A2 is assigned for the early data forwarding for the service bearers of the T-SN. In steps 1106b-1107b, the address A1 assigned by the T-SN is associated with the address A2 assigned by the T-MN.

In step 1106a, the candidate target master base station T-MN CU/CU-CP sends a bearer context modification request message or other messages to the candidate target master base station T-MN CU-UP, to instruct the T-MN CU-UP to establish service bearers and assign address information A2 for early data forwarding. If the purpose of the establishment of the service bearers is not to transmit service data with the UE, but to realize indirect data forwarding, that is, to realize the association of address information A1 and A2, then the T-MN CU-UP does not need to establish a packet data convergence protocol (PDCP) entity and/or service data adaptation protocol (SDAP) entity for these service bearers. Therefore, the request message will contain indication information which is used to indicate the T-MN CU-UP to determine whether entities such as PDCP and/or SDAP need to be established for the established service bearers. The content of the indication information is related to the used indirect data forwarding indication mode, and two indirect data forwarding indication modes are provided in the present disclosure. The specific content of the indication information refers to indirect data forwarding indication mode 1 or indirect data forwarding indication mode 2. The message contains at least one of the following information:
(1) UE ID information, containing the UE ID allocated by the base station CU-CP, that is, gNB-CU-CP UE E1AP ID.
(2) Service information, indicating the service information that needs to be established by the CU-UP. The established service may be in the form of DRBs (data Radio Bearers) or PDU sessions, containing DRB IDs or PDU session IDs. The service information will contain one or more PDU session information to be setup, and the PDU Session information contains at least one of the following information:
   PDU session IDs;
   PDU session data forwarding information request.
   DRB information to be setup, including one or more DRB information to be setup, the DRB information contains at least one of the following information:
   DRB IDs, that is, IDs of DRBs to be setup or modified;
   SDAP configuration;
   PDCP configuration;
   Cell group information;
   QoS flows information to be setup;
   DRB data forwarding information request.

The PDU session IDs are mandatory (or called mandatory information, or information that must be contained), and the PDU session data forwarding information request is optional (or called optional information, or information that is optionally contained). The DRB IDs are mandatory, while other information including SDAP configuration, PDCP configuration, cell group information, QoS flows information to be setup and DRB data forwarding request information is optional.

If the service information contains the PDU session IDs and/or DRB IDs and/or PDU session data forwarding information request and/or DRB data forwarding information request, but does not contain the SDAP configuration, PDCP configuration, cell group information and QoS flows information to be setup of the PDU sessions and/or DRBs, it indicates that the PDU sessions and/or DRBs are established for indirect data forwarding. The candidate T-MN CU-UP needs perform address allocation according to the PDU session data forwarding information request and/or DRB data forwarding information request, and the address will be sent to the source side for data forwarding from the source side to the target side. The candidate T-MN CU-UP does not need to establish a PDCP entity and/or SDAP entity for the PDU sessions and/or DRBs, that is, the received data of the PDU sessions and/or DRBs is only forwarded but not processed.

By not containing the SDAP configuration, PDCP configuration, cell group information and QoS flows information to be setup of the PDU sessions and/or DRBs in the service information, the candidate target master base station T-MN CU-UP is indicated that the PDU sessions and/or DRBs are established for indirect data forwarding, which is called indirect data forwarding indication mode 1.
(3) Data forwarding request information. Data forwarding may be based on DRBs or PDU sessions. Therefore, for DRB-based data forwarding, the data forwarding request information will contain DRB IDs and a data forwarding request. For PDU session-based data forwarding, the data forwarding request information will contain PDU session IDs and a data forwarding request.
(4) Indirect data forwarding indication information. This information is optional. If the bearer context modification request message or other messages contain the indication information, it indicates the CU-UP to only buffer the service data to be established in the service information, without data processing. Therefore, the CU-UP does not need to establish a PDCP or SDAP entity, and ignores the corresponding PDCP or SDAP configuration information. The indication information is also provided based on the DRB IDs or PDU session IDs. By sending the indirect data forwarding indication information, the processing load of the CU-UP is reduced. By first buffering the forwarded data in the intermediate node, the transmission overhead caused by data forwarding between multiple nodes is reduced. By using the indirect data forwarding indication information, the candidate target master base station T-MN CU-UP is indicated that the PDU sessions and/or DRBs are established for indirect data forwarding, which is called indirect data forwarding indication mode 2. The specific operation of the candidate target T-MN CU-UP refers to the indirect data forwarding indication mode 1 and will not be repeated here. The bearer context modification request message may be a BEARER CONTEXT MODIFICATION REQUEST message, or other messages.

In step 1107a, the candidate target master base station T-MN CU-UP sends a bearer context modification response message to the candidate target master base station T-MN CU/CU-CP, and the T-MN CU-UP provides a data forwarding address A2 for the services established for indirect data forwarding. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Established DRB list information, containing the ID of each DRB, that is, DRB ID, and further containing uplink and downlink data forwarding address information, that is, user plane transport layer address information for uplink and downlink data forwarding, containing IP addresses and tunnel IDs (GTP-TEIDs). The address information is sent to the source side through a handover request acknowledge message for allowing the source side to forward data to said address.
(3) Established PDU session list information, containing the ID of each PDU session, that is, PDU session ID, and further containing uplink and downlink data forwarding address information, that is, user plane transport layer address information for uplink and downlink data forwarding, containing IP addresses and tunnel IDs (GTP-TEIDs). The address information is sent to the source side through a handover request acknowledge message for allowing the source side to send data to the address.

The bearer context modification response message may be a BEARER CONTEXT MODIFICATION RESPONSE message, or other messages.

In step 1106b, the candidate target master base station T-MN CU/CU-CP sends a bearer context modification request message to the candidate target master base station T-MN CU-UP, and provides address information for the services established by the T-MN CU-UP for indirect data forwarding. The address information is the address information A1 provided by the T-SN. The T-MN CU-UP associates the received address information A1 with the address information A2 assigned in the step 1107a. The candidate T-MN CU-UP forwards the data received on the address A2 to the address A1, so as to send the data from the source side to the candidate target secondary base station T-SN by indirect data forwarding. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Modified PDU session resource list information, containing:
(2.1) Modified PDU session IDs.
(2.2) PDU session data forwarding information, containing uplink and downlink data forwarding address information, that is, user plane transport layer address information for uplink and downlink data forwarding, containing IP addresses and tunnel IDs (GTP-TEIDs).
(3) Modified DRB list information, containing:
(3.1) Modified DRB IDs.
(3.2) DRB data forwarding information, that is, DRB Data forwarding information, containing uplink and downlink data forwarding address information, that is, user plane transport layer address information for uplink and downlink data forwarding, containing IP addresses and tunnel IDs (GTP-TEIDs).

The bearer context modification request message may be a BEARER CONTEXT MODIFICATION REQUEST message, or other messages.

In step 1107b, the candidate target master base station T-MN CU-UP sends a bearer context modification response message to the candidate target master base station T-MN CU/CU-CP, to indicate to the T-MN CU/CU-CP that the T-MN CU-UP completes the association of data forwarding address information for indirect data forwarding.

The bearer context modification response message may be a BEARER CONTEXT MODIFICATION RESPONSE message, or other messages.

In step 1108, the candidate target master base station (T-MN CU/CU-CP) sends a handover request acknowledge message or other messages to the source master base station (S-MN CU/CU-CP), to transmit the handover configuration information and address information for data forwarding. The message contains at least one of the following information:
(1) UE ID information, containing the ID of the UE on the source base station (Source NG-RAN node UE XnAP ID) and the ID of the UE on the candidate target base station (Target NG-RAN node UE XnAP ID).
(2) Identity of the requested candidate target cell, indicating the ID of the target cell requested to handover corresponding to the acknowledge message, that is, the requested target cell ID, which may be E-UTRA CGI or NR CGI.
(3) Container from the candidate target base station to the source base station, that is, the target NG-RAN node to source NG-RAN node transparent container, containing a HandoverCommand message. The message contains the CG configurations provided by the candidate target master base station for the UE in the candidate PCells and in the candidate PSCells (containing MCG and SCG configuration information).
(4) Data forwarding address information, indicating the data forwarding address of the PDU sessions or DRBs established by the candidate target base station or the candidate target secondary base station. Data forwarding may be PDU session-based data forwarding or DRB-based data forwarding.
(4.1) For PDU session-based data forwarding, the data forwarding address information contains PDU session IDs and uplink and downlink data forwarding address information, that is, user plane transport layer address information for uplink and downlink data forwarding, containing IP addresses and tunnel IDs (GTP-TEIDs).
(4.2) For DRB-based data forwarding, the data forwarding address information contains DRB IDs and uplink and downlink data forwarding address information, that is, user plane transport layer address information for uplink and downlink data forwarding, containing IP addresses and tunnel IDs (GTP-TEIDs).

If the address information will be used for early data forwarding of the service bearers of the UE in the S-SN:
If the data forwarding of the S-SN adopts direct data forwarding, that is, the S-SN directly sends data to the candidate target T-MN or the candidate target T-SN, then step 1111 is directly executed, and the S-MN sends data forwarding address information received in the handover request message to the S-SN.
If the data forwarding of the S-SN adopts indirect data forwarding, that is, the data sent to the target side is forwarded by the S-MN, then it is necessary to establish, at the S-MN, the service bearers of the UE on the S-SN, and assign address information A3 for early data forwarding of these service bearers. After the address A3 is provided to the S-SN in the step 1111, the S-SN considers the address A3 as the address for receiving the forwarded data of the service bearers of the UE, and forwards the service data of the UE on the S-SN to the address A3. Meanwhile, the S-MN also needs to associate the address A3 with the forwarding address information received by the S-MN from the candidate target base station according to the service bearers, so that the forwarded data received from the S-SN can be correctly forwarded to the candidate T-MN/T-SN. Through the steps 1109a-1110b, if indirect data forwarding is used for the data of the S-SN, then steps 1109a-1110b will be executed first, in which the S-MN assigns an address A3 for indirect data forwarding, and then step 1111 is executed to send the address information A3 to the S-SN for data forwarding.

In step 1109a, the source master base station S-MN CU/CU-CP sends a bearer context modification request message to the source master base station S-MN CU-UP, to instruct the S-MN CU-UP to establish service bearers and assign address information A3 for early data forwarding. If the purpose of the establishment of the service bearers is not to transmit service data with the UE, but to realize indirect data forwarding, that is, to realize the association of address information A3 with the address information provided by the candidate target base station and/or candidate target secondary base station (T-MN and/or T-SN), then the S-MN CU-UP does not need to establish a PDCP and/or SDAP entity for these service bearers. Therefore, the request message will contain indication information which is used to indicate the S-MN CU-UP to determine whether entities such as PDCP and/or SDAP need to be established for the established service bearers. The message contains at least one of the following information:
(1) UE ID information, containing the UE ID allocated by the base station CU-CP, that is, gNB-CU-CP UE E1AP ID.
(2) Service information, indicating the service information that needs to be established by the CU-UP. The established service may be in the form of DRBs (data Radio Bearers) or PDU sessions, containing DRB IDs or PDU session IDs. The specific description of the service information refers to the step 1106a and will not be repeated here.

If the indirect data forwarding indication mode 1 is adopted, by not containing the SDAP configuration, PDCP configuration, cell group information and QoS flows information to be setup of the PDU sessions and/or DRBs in the service information, the source master base station S-MN CU-UP is indicated that the PDU sessions and/or DRBs are established for indirect data forwarding. The source S-MN CU-UP needs to perform address allocation according to the PDU session data forwarding information request and/or DRB data forwarding information request, and the address is sent to the source secondary base station for data forwarding. The source S-MN CU-UP does not need to establish a PDCP entity and/or SDAP entity for the PDU sessions and/or DRBs, that is, the received data of the PDU sessions and/or DRBs is only forwarded but not processed.
(3) Data forwarding request information. Data forwarding may be based on DRBs or PDU sessions. Therefore, for DRB-based data forwarding, the data forwarding request information will contain DRB IDs and a data forwarding request. For PDU session-based data forwarding, the data forwarding request information will contain PDU session IDs and a data forwarding request.
(4) Indirect data forwarding indication information. This information is optional. If the bearer context modification request message contains the indication information, it indicates the CU-UP to only buffer the service data to be established in the service information, without data processing. Therefore, the CU-UP does not need to establish a PDCP or SDAP entity, and ignores the corresponding PDCP or SDAP configuration information. The indication information is also provided based on the DRB IDs or PDU session IDs. By sending the indirect data forwarding indication information, the processing load of the CU-UP is reduced. By first buffering the forwarded data in the intermediate node, the transmission overhead caused by data forwarding between multiple nodes is reduced.

If the indirect data forwarding indication mode 2 is adopted, by using the indirect data forwarding indication information, the source master base station S-MN CU-UP is indicated that the PDU sessions and/or DRBs are established for indirect data forwarding and do not need to be processed. The specific operation of the source S-MN CU-UP is the same as that in the indirect data forwarding indication mode 1 and will not be repeated here.

The bearer context modification request message may be a BEARER CONTEXT MODIFICATION REQUEST message, or other messages.

In step 1110a, the source master base station S-MN CU-UP sends a bearer context modification response message to the source master base station S-MN CU/CU-CP, and the S-MN CU-UP provides a data forwarding address A3 for the services established for indirect data forwarding. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Established DRB list information, containing the ID of each DRB, that is, DRB ID, and further containing uplink and downlink data forwarding address information, that is, user plane transport layer address information for uplink and downlink data forwarding, containing IP addresses and tunnel IDs (GTP-TEIDs).
(3) Established PDU session list information, containing the ID of each PDU session, that is, PDU session ID, and further containing uplink and downlink data forwarding address information, that is, user plane transport layer address information for uplink and downlink data forwarding, containing IP addresses and tunnel IDs (GTP-TEIDs).

The bearer context modification response message may be a BEARER CONTEXT MODIFICATION RESPONSE message, or other messages.

In step 1109b, the source master base station S-MN CU/CU-CP sends a bearer context modification request message to the source master base station S-MN CU-UP, and provides address information for the services established by the S-MN CU-UP for indirect data forwarding. The address information is the address information provided by the candidate target base station and/or candidate target secondary base station (T-MN and/or T-SN). The S-MN CU-UP associates the received address information with the address information A3 assigned in the step 1109a. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Modified PDU session resource list information, containing:
(2.1) Modified PDU session IDs.
(2.2) PDU session data forwarding information, containing uplink and downlink data forwarding address information, that is, user plane transport layer address information for uplink and downlink data forwarding, containing IP addresses and tunnel IDs (GTP-TEIDs).
(3) Modified DRB list information, containing:
(3.1) Modified DRB IDs.
(3.2) DRB data forwarding information, containing uplink and downlink data forwarding address information, that is, user plane transport layer address information for uplink and downlink data forwarding, containing IP addresses and tunnel IDs (GTP-TEIDs).

The bearer context modification request message may be a BEARER CONTEXT MODIFICATION REQUEST message, or other messages.

In step 1110b, the source master base station S-MN CU-UP sends a bearer context modification response message to the source master base station S-MN CU/CU-CP, to indicate to the S-MN CU/CU-CP that the S-MN CU-UP completes the association of data forwarding address information for indirect data forwarding.

The bearer context modification response message may be a BEARER CONTEXT MODIFICATION RESPONSE message, or other messages.

In step 1111, the source master base station sends an address indication message to the source secondary base station to provide data forwarding address information. The address information is the data forwarding address A3 provided by the source S-MN CU-UP.

The message contains at least one of the following information:
(1) UE ID information, containing the ID of the UE on the master base station (M-NG-RAN node UE XnAP ID) and the ID of the UE on the candidate secondary base station (S-NG-RAN node UE XnAP ID).
(2) Data forwarding address information. Data forwarding may be PDU session-based data forwarding or DRB-based data forwarding.
(2.1) For PDU session-based data forwarding, the data forwarding address information contains PDU session IDs and uplink and downlink data forwarding address information, that is, user plane transport layer address information for uplink and downlink data forwarding, containing IP addresses and tunnel IDs (GTP-TEIDs).
(2.2) For DRB-based data forwarding, the data forwarding address information contains DRB IDs and uplink and downlink data forwarding address information, that is, user plane transport layer address information for uplink and downlink data forwarding, containing IP addresses and tunnel IDs (GTP-TEIDs).

The address indication message may be an Xn-U address indication message or other messages.

When the CHO execution conditions are satisfied, after the UE selects a target PCell and accesses the target PCell, the target T-MN CU-CP will send a message to indicate the T-MN CU-UP to forward the service bearer data of the candidate T-SN to the candidate T-SN.

The indication message may be a UE CONTEXT MODIFICATION REQUEST or other messages.

When the CHO execution conditions are satisfied, after the UE selects and accesses a target PCell, the target T-MN CU-CP will indicate the T-MN CU-UP to forward the buffered service bearer data of the T-SN to the candidate T-SN.

### Embodiment 11: Forwarded Data Transmission Method

Before the execution of CHO+CPAC, the service bearers of the UE change, resulting in new service bearers in the candidate T-SN. Or, because the load of the candidate T-MN becomes heavy, it is necessary to establish new service bearers on the candidate T-SN. Therefore, when the candidate T-SN is adjusted or new service bearers are established on the candidate T-SN, it is inevitable to perform forwarded data transmission to multiple candidate T-SNs. Therefore, FIG. 13 shows the basic flow of the forwarded data transmission method when handover configuration is updated/modified. Unnecessary data transmission between nodes is reduced, the transmission overhead caused by data forwarding between multiple nodes is reduced, and the increase in processing load on the data forwarding node (e.g., T-MN) is avoided.

In step 1201, the source base station sends a handover request message to the candidate target master base station. Before the execution of CHO+CPAC, if the service of the UE changes, the source base station notifies the candidate target base station through the message.

In steps 1202-1203, the candidate target master base station T-MN CU/CU-CP performs a bearer context modification process between the candidate target master base stations T-MN CU-UPs. In step 1201, the source base station may indicate to the candidate T-MN that the UE has new services, and the candidate T-MN may carry the new services on the candidate T-MN and/or T-SN according to the load of the T-MN and T-SN. If the new services are borne on the candidate T-SN, steps 1204-1205 will be executed.

The bearer context modification request message may be a BEARER CONTEXT MODIFICATION REQUEST message, or other messages. The bearer context modification response message may be a BEARER CONTEXT MODIFICATION RESPONSE message, or other messages.

In steps 1204-1205, the candidate target master base station completes a secondary node modification process between the candidate target secondary base stations. If the candidate T-SN will bear the new services, the candidate T-SN will modify SCG configuration resources for the new services. If early data forwarding is supported, the T-SN also needs to provide data forwarding address information for service data forwarding.

Steps 1206a-1208 are the same as steps 1106a-1108 and will not be repeated here.

Based on the same principle as the method provided by the embodiments of the present disclosure, the embodiments of the present disclosure provide an electronic device, including: a transceiver; and a processor, coupled to the transceiver and configured to implement the method provided in any optional embodiment of the present disclosure. Optionally, the electronic device may be implemented as a first node, a second node, a third node, a fourth node, a fifth node, a sixth node, a seventh node, an eighth node, a ninth node, or a terminal. The device includes a transceiver; and a processor, coupled to the transceiver and configured to execute the method provided in any optional embodiment of the present disclosure.

### Embodiment 12: Another Forwarded Data Transmission Method

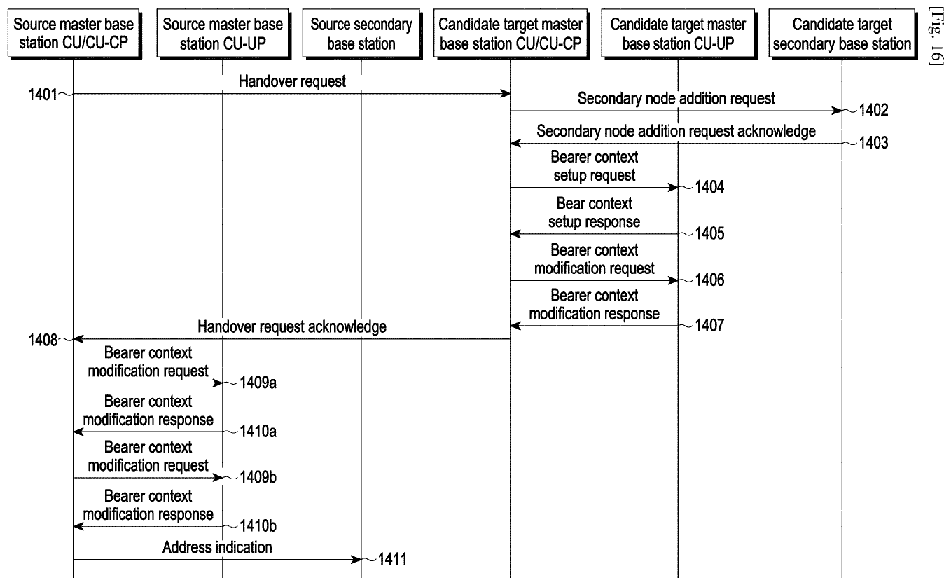

FIG. 15 shows the basic flow of the forwarded data transmission method in the handover preparation stage. The mechanisms and beneficial effects are the same as those in Embodiment 10, for realizing that the service bearers established on the candidate T-SN adopt indirect early data forwarding. That is, the data forwarded by the source base station S-MN or the source secondary base station S-SN to the candidate T-SN is first sent to the candidate master base station T-MN, and then the candidate master base station T-MN sends it to the candidate target secondary base station T-SN.

Embodiment 12 mainly differs from Embodiment 10 in the flow design, specifically:
Steps 1301-1305 are the same as the steps 1101-1105 and will not be repeated here.

In steps 1306-1307, the candidate T-MN establishes service beaters of the candidate T-SN and assigns address information A2 for early data forwarding for the service bearers of the T-SN, and associates the address A1 assigned by the T-SN with the address A2 assigned by the T-MN.

The A2 address is sent to the source side. The candidate T-MN CU-UP forwards the received data from the address A2 to the address A1, so as to send the data from the source side to the candidate target secondary base station T-SN by indirect data forwarding.

In step 1306, the candidate target master base station T-MN CU/CU-CP sends a bearer context modification request message or other messages to the candidate target master base station T-MN CU-UP, to provide the address A1 assigned by the candidate T-SN. After the T-MN CU-UP completes the establishment of T-SN service bearers, the address A2 is assigned to the T-SN service bearers, and the address A1 is associated with the address A2.

The message contains at least one of the following information:
(1) UE ID information, containing the UE ID allocated by the base station CU-CP, that is, gNB-CU-CP UE E1AP ID.
(2) Service information, indicating the service information that needs to be established by the CU-UP. The service information will contain one or more PDU session information to be setup, and the PDU Session information contains at least one of the following information:
   PDU session IDs;
   PDU session data forwarding information request;
   PDU session data forwarding information, containing uplink and downlink data forwarding address information, that is, user plane transport layer address information for uplink and downlink data forwarding, containing IP addresses and tunnel IDs (GTP-TEIDs). The address information is the address A1 assigned by the candidate T-SN.
   DRB information to be setup, containing one or more DRB information to be setup, the DRB information contains at least one of the following information:
   DRB IDs, that is, IDs of DRBs to be setup or modified;
   SDAP configuration;
   PDCP configuration;
   Cell group information;
   QoS flows information to be setup;
   DRB data forwarding information request;
   DRB data forwarding information, containing uplink and downlink data forwarding address information, that is, user plane transport layer address information for uplink and downlink data forwarding, containing IP addresses and tunnel IDs (GTP-TEIDs). The address information is the address A1 assigned by the candidate T-SN.

The PDU session IDs are mandatory (or called mandatory information), and the PDU session data forwarding information request and the PDU Session data forwarding information are optional (or called optional information). The DRB IDs are mandatory, while other information including SDAP configuration, PDCP configuration, cell group information, QoS flows information to be setup, DRB data forwarding request information and DRB data forwarding information is optional.
(3) Indirect data forwarding request information. This information is optional. If the bearer context modification request message or other messages contain the indication information, it indicates the CU-UP to only buffer the service data to be established in the service information, without data processing. Therefore, the CU-UP does not need to establish a PDCP or SDAP entity, and ignores the corresponding PDCP or SDAP configuration information. The indication information is also provided based on the DRB IDs or PDU session IDs. By sending the indirect data forwarding indication information, the processing load of the CU-UP is reduced. By first buffering the forwarded data in the intermediate node, the transmission overhead caused by data forwarding between multiple nodes is reduced.

By the indirect data forwarding indication mode 1 or 2, the candidate T-MN CU-UP determines the PDU session and/or DRB established for indirect data forwarding, and performs address allocation according to the PDU session data forwarding information request and/or the DRB data forwarding information request. The address is sent to the source side for allowing the source side to forward data to the target side. The candidate T-MN CU-UP forwards the received forwarded data to the address in the PDU Session data forwarding information and/or the DRB data forwarding information.

The bearer context modification request message may be a BEARER CONTEXT MODIFICATION REQUEST message, or other messages.

In step 1307, the candidate target master base station T-MN CU-UP sends a bearer context modification response message or other messages to the candidate target master base station T-MN CU/CU-CP, and the T-MN CU-UP provides a data forwarding address A2 for the service bearers established for indirect data forwarding. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Established DRB list information, containing the ID of each DRB, that is, DRB ID, and further containing uplink and downlink data forwarding address information, that is, user plane transport layer address information for uplink and downlink data forwarding, containing IP addresses and tunnel IDs (GTP-TEIDs). The address information is sent to the source side through a handover request acknowledge message for allowing the source side to forward data to the address.
(3) Established PDU session list information, containing the ID of each PDU session, that is, PDU session ID, and further containing uplink and downlink data forwarding address information, that is, user plane transport layer address information for uplink and downlink data forwarding, containing IP addresses and tunnel IDs (GTP-TEIDs). The address information is sent to the source side through a handover request acknowledge message for allowing the source side to send data to the address.

The bearer context modification response message may be a BEARER CONTEXT MODIFICATION RESPONSE message, or other messages.

Step 1308 is the same as the step 1108 and will not be repeated here.

If the address information in the step 1308 will be used for early data forwarding of the service bearers of the UE in the S-SN:
If the data forwarding of the S-SN adopts direct data forwarding, that is, the S-SN directly sends data to the candidate target T-MN or the candidate target T-SN, then step 1311 is directly executed, and the S-MN sends data forwarding address information received in the handover request acknowledge message to the S-SN.
If the data forwarding of the S-SN adopts indirect data forwarding, that is, the data sent to the target side is forwarded by the S-MN, then it is necessary to establish, at the S-MN, the service bearers of the UE on the S-SN, and assign address information A3 for early data forwarding of these service bearers. After the address A3 is provided to the S-SN in the step 1311, the S-SN forwards the service data of the UE on the S-SN to the address A3. Meanwhile, the S-MN also needs to associate the address A3 with the forwarding address information received by the S-MN from the candidate target base station according to the service bearers, so that the forwarded data received from the S-SN can be correctly forwarded to the candidate T-MN/T-SN. Through the steps 1309-1310, the S-MN assigns an address A3 for indirect data forwarding, and then step 1311 is executed to send the address information A3 to the S-SN for data forwarding. After the S-MN receives the data from the A3 address, the data is forwarded to the address obtained in the step 1308, so that the data of the S-SN is sent to the target side by indirect data forwarding.

In step 1309, the source master base station S-MN CU/CU-CP sends a bearer context modification request message or other messages to the source master base station S-MN CU-UP, to instruct the S-MN CU-UP to establish service bearers, assign address information A3 for early data forwarding for these service bearers and associate the address A3 with the address information provided by the candidate target base station and/or the candidate target secondary base station (T-MN and/or T-SN) according to the service bearers, so that the data on the source S-SN is forwarded to the target side by indirect data forwarding. The message contains at least one of the following information:
(1) UE ID information, containing the UE ID allocated by the base station CU-CP, that is, gNB-CU-CP UE E1AP ID.
(2) Service information, indicating the service information that needs to be established by the CU-UP. The service information will contain one or more PDU session information to be setup, and the PDU Session information contains at least one of the following information:
   PDU session IDs;
   PDU session data forwarding information request;
   PDU session data forwarding information, containing uplink and downlink data forwarding address information, that is, user plane transport layer address information for uplink and downlink data forwarding, containing IP addresses and tunnel IDs (GTP-TEIDs). The address information is the address information provided by the candidate target base station and/or candidate target secondary base station (T-MN and/or (T-SN).
   DRB information to be setup, containing one or more DRB information to be setup, the DRB information contains at least one of the following information:
   DRB IDs, that is, IDs of DRBs to be setup or modified;
   SDAP configuration;
   PDCP configuration;
   Cell group information;
   QoS flows information to be setup;
   DRB data forwarding information request;
   DRB data forwarding information, containing uplink and downlink data forwarding address information, that is, user plane transport layer address information for uplink and downlink data forwarding, containing IP addresses and tunnel IDs (GTP-TEIDs). The address information is the address information provided by the candidate target base station and/or candidate target secondary base station (T-MN and/or (T-SN).

The PDU session IDs are mandatory, and the PDU session data forwarding information request and the PDU session data forwarding information are optional. The DRB IDs are mandatory, while other information including SDAP configuration, PDCP configuration, cell group information, QoS flows information to be setup, DRB data forwarding request information and DRB data forwarding information is optional.
(3) Indirect data forwarding request information. This information is optional. If the bearer context modification request message or other messages contain the indication information, it indicates the CU-UP to only buffer the service data to be established in the service information, without data processing. Therefore, the CU-UP does not need to establish a PDCP or SDAP entity, and ignores the corresponding PDCP or SDAP configuration information. The indication information is also provided based on the DRB IDs or PDU session IDs. By sending the indirect data forwarding indication information, the processing load of the CU-UP is reduced. By first buffering the forwarded data in the intermediate node, the transmission overhead caused by data forwarding between multiple nodes is reduced.

By the indirect data forwarding indication mode 1 or 2, the source S-MN CU-UP determines the PDU session and/or DRB established for indirect data forwarding, and performs address A3 allocation according to the PDU session data forwarding information request and/or the DRB data forwarding information request. The address is sent to the source S-SN for data forwarding. The source S-MN CU-UP forwards the received forwarded data to the address in the PDU Session data forwarding information and/or the DRB data forwarding information, that is, to the target side.

The bearer context modification request message may be a BEARER CONTEXT MODIFICATION REQUEST message, or other messages.

In step 1310, the source master base station S-MN CU-UP sends a bearer context modification response message to the source master base station S-MN CU/CU-CP, and the S-MN CU-UP provides a data forwarding address A3 for the services established for indirect data forwarding. The message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Established DRB list information, containing the ID of each DRB, that is, DRB ID, and further containing uplink and downlink data forwarding address information, that is, user plane transport layer address information for uplink and downlink data forwarding, containing IP addresses and tunnel IDs (GTP-TEIDs).
(3) Established PDU session list information, containing the ID of each PDU session, that is, PDU session ID, and further containing uplink and downlink data forwarding address information, that is, user plane transport layer address information for uplink and downlink data forwarding, containing IP addresses and tunnel IDs (GTP-TEIDs).

The bearer context modification response message may be a BEARER CONTEXT MODIFICATION RESPONSE message, or other messages.

Step 1311 is the same as the step 1111 and will not be repeated here.

When the CHO execution conditions are satisfied, after the UE selects and accesses a target PCell, the target T-MN CU-CP instructs the T-MN CU-UP to forward the buffered service bearer data of the T-SN to the candidate T-SN.

### Embodiment 13: Another Forwarded Data Transmission Method

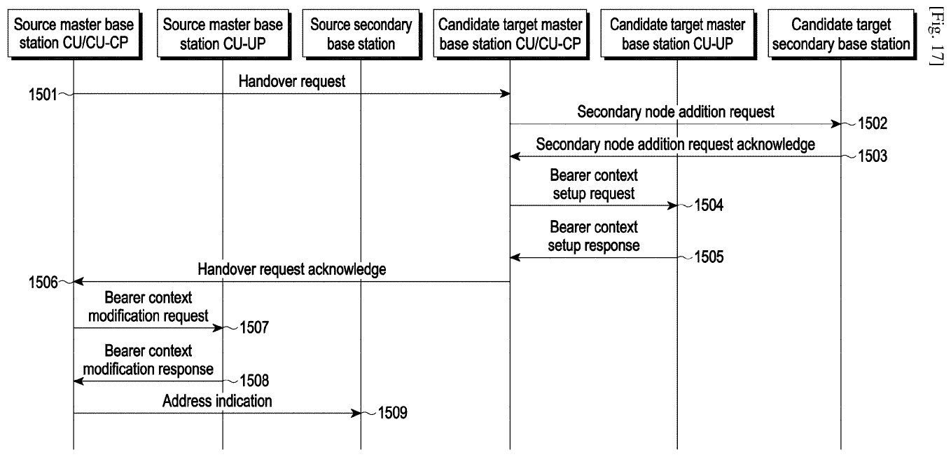

FIG. 16 shows the basic flow of the forwarded data transmission method in the handover preparation stage. The mechanism is basically the same as that in Embodiment 10, for realizing that the data of the service bearers established on the T-SN adopts indirect early data forwarding. This embodiment differs from Embodiment 10 in that: after the addition of the candidate target secondary base station T-SN is completed, the candidate target master T-MN establishes service bearers of the T-MN and service bearers of the T-SN of the UE simultaneously on the T-MN CU-UP. The purpose of establishing service bearers of the T-SN on the T-MN CU-UP is to realize the indirect early data forwarding of the data of service bearers of the T-SN. The specific flow is described below.

Step 1401 is the same as the step 1101 and will not be repeated here.

Steps 1402-1403 are the same as the steps 1104-1105 and will not be repeated here.

In step 1404, the candidate target master base station T-MN CU/CU-CP sends a bearer context setup request message or other messages to the candidate target master base station T-MN CU-UP, to instruct the T-MN CU-UP to establish service bearers (the service bearers include service bearers of the T-MN and/or service bearers of the T-SN) and assign address information for early data forwarding, including assigning addresses for the service bearers of the T-MN and the service bearers of the T-SN, wherein the address A2 assigned for the service bearers of the T-SN is used for indirect data forwarding. The specific description of this step refers to the step 1106a, but this step differs from the step 1106a in that the established service bearers include service bearers of the T-MN and service bearers of the T-SN. For the service bearers of the T-MN, the service information will contain the SDAP configuration, PDCP configuration, cell group information, QoS flows information to be setup and other information. For the service bearers of the T-SN, by the indirect data forwarding indication mode 1 or 2, the candidate T-MN CU-UP is indicated that the service bearers are established for sending the data from the source side to the T-SN by indirect data forwarding. The specific behavior of the candidate T-MN CU-UP refers to the step 1106a and will not be repeated here.

The bearer context setup request message may be a BEARER CONTEXT SETUP REQUEST message, or other messages.

In step 1405, the candidate target master base station T-MN CU-UP sends a bearer context setup response message or other messages to the candidate target master base station T-MN CU/CU-CP. The T-MN CU-UP provides address information for data forwarding for the established service bearers, and the address information is sent to the source side through a handover request message. For the service bearers established for indirect data forwarding (the service bearers of the T-SN), a data forwarding address A2 is provided. This message contains at least one of the following information:
(1) UE ID information, containing the UE ID allocated by the base station CU-CP and the UE ID allocated by the base station CU-UP, that is, gNB-CU-CP UE E1AP ID and gNB-CU-UP UE E1AP ID.
(2) Established DRB list information, containing the ID of each DRB, that is, DRB ID, and further containing uplink and downlink data forwarding address information, that is, user plane transport layer address information for uplink and downlink data forwarding, containing IP addresses and tunnel IDs (GTP-TEIDs).
(3) Established PDU session list information, containing the ID of each PDU session, that is, PDU session ID, and further containing uplink and downlink data forwarding address information, that is, user plane transport layer address information for uplink and downlink data forwarding, containing IP addresses and tunnel IDs (GTP-TEIDs).

The bearer context modification response message may be a BEARER CONTEXT MODIFICATION RESPONSE message, or other messages.

Steps 1406-1407 are the same as the steps 1106b-1107b and will not be repeated here.

Steps 1408-1411 are the same as the steps 1108-1111 and will not be repeated here.

When the CHO execution conditions are satisfied, after the UE selects and accesses a target PCell, the target T-MN CU-CP instructs the T-MN CU-UP to forward the buffered data of the service bearers of the T-SN to the candidate T-SN.

### Embodiment 14: Another Forwarded Data Transmission Method

FIG. 17 shows the basic flow of the forwarded data transmission method in the handover preparation stage. The mechanism is basically the same as that in Embodiment 12, for realizing that the service bearers established on the T-SN adopt indirect early data forwarding. This embodiment differs from Embodiment 12 in that, after the addition of the candidate target secondary base station T-SN is completed, the candidate target master base station T-MN establishes service bearers of the T-MN and service bearers of the T-SN of the UE simultaneously on the T-MN CU-UP. The purpose of establishing the service bearers of the T-SN on the T-MN CU-UP is to realize the indirect early data forwarding of the data of the service bearers of the T-SN. The specific flow is described below.

Step 1501 is the same as the step 1301 and will not be repeated here.

Steps 1502-1503 are the same as the steps 1304-1305 and will not be repeated here.

In step 1504, the candidate target master base station T-MN CU/CU-CP sends a bearer context setup request message or other messages to the candidate target master base station T-MN CU-UP, to instruct the candidate T-MN CU-UP to establish service bearers (the service bearers include service bearers of the T-MN and/or service bearers of the T-SN) and assign address information for early data forwarding, including assigning addresses for the service bearers of the T-MN and the service bearers of the T-SN, wherein the address A2 assigned for the service bearers of the T-SN is used for indirect data forwarding. The candidate T-MN CU-UP also associates the address A1 assigned by the candidate T-SN with the address A2 assigned by the candidate T-MN according to the service bearers, so that the data from the source side is forwarded to the candidate T-SN by indirect data forwarding. The specific description of this step refers to the step 1306, but this step differs from the step 1306 in that the established service bearers include the service bearers of the T-MN and the service bearers of the T-SN. For the service bearers of the T-MN, the service information will contain the SDAP configuration, PDCP configuration, cell group information, QoS flows information to be setup and other information of the PDU sessions and/or DRBs. For the service bearers of the T-SN, by the indirect data forwarding indication mode 1 or 2, the candidate T-MN CU-UP is indicated that the service bearers are established for sending the data from the source side to the T-SN by indirect data forwarding. The specific behavior of the candidate T-MN CU-UP refers to the step 1306 and will not be repeated here.

The bearer context setup request may be a BEARER CONTEXT SETUP REQUEST message, or other messages.

In step 1505, the candidate target master base station T-MN CU-UP sends a bearer context setup response message or other messages to the candidate target master base station T-MN CU/CU-CP. The T-MN CU-UP provides address information for data forwarding for the established service bearers, and the address information is sent to the source side through a handover request message. For the service bearers established for indirect data forwarding (the service bearers of the T-SN), a data forwarding address A2 is provided. The specific description refers to the step 1405 and will not be repeated here.

Steps 1506-1509 are the same as the steps 1308-1311 and will not be repeated here.

When the CHO execution conditions are satisfied, after the UE selects and accesses a target PCell, the target T-MN CU-CP instructs the T-MN CU-UP to forward the buffered data of the service bearers of the T-SN to the candidate T-SN.

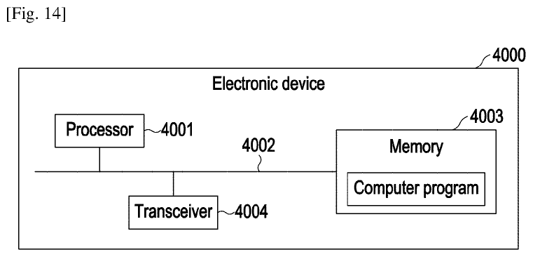

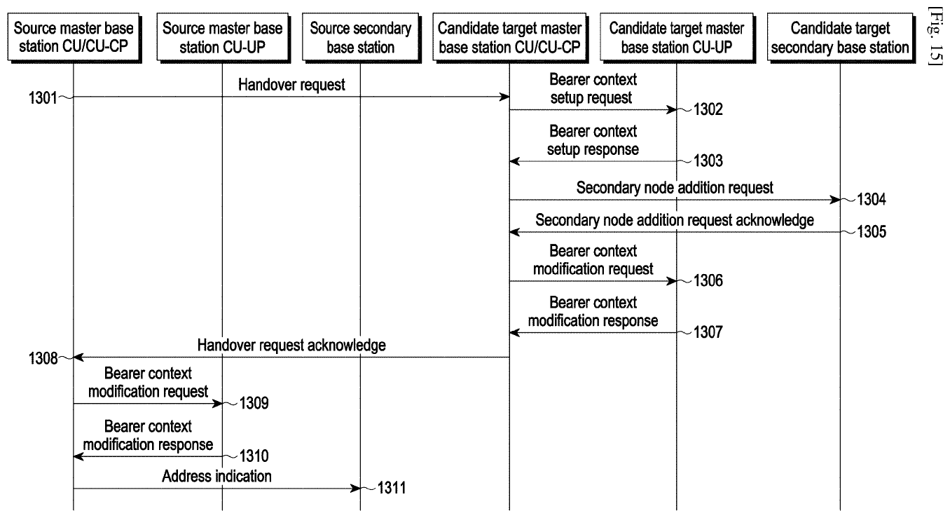

FIG. 14 shows a schematic structure diagram of an electronic device provided in an optional embodiment of the present disclosure. As shown in FIG. 14, the electronic device 4000 in FIG. 14 includes a processor 4001 and a memory 4003. Wherein, the processor 4001 communicates with the memory 4003, e.g., via a bus 4002. Optionally, the electronic device 4000 may also include a transceiver 4004, which may be used for data interaction between this electronic device and other electronic devices, such as data transmission and/or data reception. It is to be noted that, in practical applications, the number of the transceiver 4004 is not limited to one, and the structure of the electronic device 4000 does not constitute any limitation to the embodiments of the present disclosure.

The processor 4001 may be a central processing unit (CPU), a general-purpose processor, a digital signal processor (DSP), an application specific integrated circuit (ASIC), and a field programmable gate array (FPGA), or other programmable logic device, transistor logic device, hardware component, or any combination thereof. It is possible to implement or execute the various exemplary logical blocks, modules and circuits described public in combination with the disclosures of the present disclosure. The processor 4001 may also be a combination for realizing computing functions, for example, a combination of one or more microprocessors, a combination of DSPs and microprocessors, etc.

The bus 4002 can include a path for delivering information among the above components. The bus 4002 may be a peripheral component interconnect (PCI) bus, an extended industry standard architecture (EISA) bus, etc. The bus 4002 may be divided into an address bus, a data bus, a control bus, and so on. For ease of illustration, only one bold line is shown in FIG. 14, but does not indicate that there is only one bus or type of bus.

The memory 4003 may be a read only memory (ROM) or other types of static storage devices that can store static information and instructions, a random access memory (RAM) or other types of storage devices that can store information and instructions. The memory 4003 may also be electrically erasable programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage medium or other magnetic storage device, or any other medium capable of carrying or storing desired program code in the form of instructions or data structures and capable of being accessed by a computer, but not limited to this.

The memory 4003 is configured to store application program codes (computer programs) for executing the solutions of the present disclosure, and the processor 4001 controls the execution. The processor 4001 is configured to execute application program codes stored in the memory 4003 to implement what is shown in the foregoing method embodiment.

It should be understood that although the each of steps in the flowchart of the figures are sequentially shown as the arrows, these steps are not necessarily performed in the order indicated by the arrows. Unless explicitly stated herein, the execution order of these steps is not strictly limited, and they can be performed in other orders. Moreover, at least some of the steps in the flowcharts shown in the drawings may include multiple sub-steps or multiple stages. These sub-steps or stages are not necessarily performed at the same moment of time, and instead, may be performed at different moments of time. The sub-steps or stages are not necessarily performed sequentially, and instead, may be performed in turn or alternately with other steps or at least some of the sub-steps or stages of other steps.

What described above are some implementations of the present disclosure. It should be noted that, for a person of ordinary skill in the art, a number of improvements and modifications may be made without departing from the principle of the present disclosure, and those improvements and modifications shall also be regarded as falling into the protection scope of the present disclosure.

1-15. (canceled)

16. A method performed by a base station in a wireless communication system, the method comprising:
transmitting, by a central unit-control plane (CU-CP) of the base station, a bearer context setup request message to setup at least one bearer to a central unit-user plane (CU-UP) of the base station, wherein the bearer context setup request message includes information related to indirect data forwarding; and
receiving, by the CU-CP of the base station, a bearer context setup response message from the CU-UP in response to the bearer context setup request message.

17. The method of claim 16, wherein the information related to the indirect data forwarding indicates to the CU-UP that the at least one bearer is being set up for the indirect data forwarding.

18. The method of claim 16, further comprising transmitting, by the CU-CP of the base station, a bearer context modification request message to the CU-UP,
wherein the bearer context modification request message includes at least one of a modified protocol data unit (PDU) session identifier (ID), PDU session data forwarding information, a modified dedicated radio bearer (DRB) ID, or DRB data forwarding information.

19. The method of claim 16, further comprising:
transmitting a secondary node addition request message including an identifier of a primary cell (PCell) to a secondary node; and
receiving a secondary node addition acknowledge message including the identifier of the PCell from the secondary node, in response to the secondary node addition request message.

20. The method of claim 19, wherein the secondary node addition acknowledge message further includes information about a transport layer for data forwarding.

21. The method of claim 16, further comprising receiving a handover request message from a source base station,
wherein the handover request message includes information about a maximum number of at least one primary secondary cell (PSCell) to prepare a conditional handover (CHO).

22. The method of claim 21, further comprising transmitting a handover success message to the source base station,
wherein the handover success message includes an identifier (ID) of a target primary secondary cell (PSCell) selected by a user equipment (UE).

23. The method of claim 16, further comprising transmitting, to a secondary node, measurement results for the secondary node and information about a maximum number of primary secondary cells (PSCells) to prepare.

24. The method of claim 16, further comprising receiving, by a user equipment (UE), a radio resource control (RRC) reconfiguration complete message including information indicating a primary secondary cell (PSCell) selected by the UE.

25. A base station in a wireless communication system, the base station comprising:
a transceiver; and
at least one processor coupled to the transceiver, wherein the at least one processor is configured to:
transmit, by a central unit-control plane (CU-CP) of the base station, a bearer context setup request message to setup at least one bearer to a central unit-user plane (CU-UP) of the base station, wherein the bearer context setup message includes information related to indirect data forwarding, and
receive, by the CU-CP of the base station, a bearer context setup response message from the CU-UP in response to the bearer context setup request message.

26. The base station of claim 25, wherein the information related to the indirect data forwarding indicates to the CU-UP that the at least one bearer is being set up for the indirect data forwarding.

27. The base station of claim 25, wherein the at least one processor is further configured to transmit, by the CU-CP of the base station, a bearer context modification request message to the CU-UP,
wherein the bearer context modification request message includes at least one of a modified protocol data unit (PDU) session identifier (ID), PDU session data forwarding information, a modified dedicated radio bearer (DRB) ID, or DRB data forwarding information.

28. The base station of claim 25, wherein the at least one processor is further configured to:
transmit a secondary node addition request message including an identifier of a primary cell (PCell) to a secondary node, and
receive a secondary node addition acknowledge message including the identifier of the PCell from the secondary node, in response to the secondary node addition request message.

29. The base station of claim 28, wherein the secondary node addition acknowledge message further includes information about a transport layer for data forwarding.

30. The base station of claim 25, wherein the at least one processor is further configured to receive a handover request message from a source base station, and
wherein the handover request message includes information about a maximum number of at least one primary secondary cell (PSCell) to prepare a conditional handover (CHO).

31. The base station of claim 30, wherein the at least one processor is further configured to transmit a handover success message to the source base station, and
wherein the handover success message includes an identifier (ID) of a target primary secondary cell (PSCell) selected by a user equipment (UE).

32. The base station of claim 25, wherein the at least one processor is further configured to transmit, to a secondary node, measurement results for the secondary node and information about a maximum number of primary secondary cells (PSCells) to prepare.

33. The base station of claim 25, wherein the at least one processor is further configured to receive, from a user equipment (UE), a radio resource control (RRC) reconfiguration complete message including information indicating a primary secondary cell (PSCell) selected by the UE.
